(19) United States
(12) Patent Application Publication
(10) Pub. No.: US 2009/0070239 A1
(43) Pub. Date: Mar. 12, 2009

(54) OPEN PLATFORM FOR UNREGISTERED SECURITIES (OPUS)

(75) Inventors: Kyle C. KERBAWY, Bloomfield Hills, MI (US); David BIRNBAUM, New York, NY (US); Sanjay KANNAMBADI, Princeton Jct, NJ (US); Mario PASSUDETTI, Chester, NY (US)

Correspondence Address: PILLSBURY WINTHROP SHAW PITTMAN, LLP, P.O. BOX 10500, MCLEAN, VA, 22102, US

(73) Assignee: THE BANK OF NEW YORK MELLON, New York, NY (US)

(21) Appl. No.: 11/852,081

(22) Filed: Sep. 7, 2007

(51) Int. Cl. G06Q 40/00

(52) U.S. Cl. 705/30; 705/35; 705/37

(57) ABSTRACT

A computer-implemented, web-interfaced method of trading and settlement of unregistered securities issued under an exception outlined in Rule 144A includes providing access to a website in communication with a network. A data structure is established and stored in a memory and includes information relating to one or more unregistered securities and entities involved with the trade. A trade request is received via the network from an interested investor, and a QIB eligibility status is determined for each of the interested investors. Eligible QIBs are allocated an investment slot if a number of allocated investment slots is less than a regulated value. Otherwise, an investment slot is denied to any remaining QIBs. A related system and computer-readable medium are also disclosed.

### BACKGROUND

Rule 144A, adopted pursuant to the U.S. Securities Act of 1933, as amended, provides a safe harbor from the registration requirements of the Securities Act of 1933 for certain private resales of restricted securities to Qualified Institutional Buyers (QIB), which generally are large institutional investors with over $100 million in investable assets. Such entities include banks, savings and loan institutions, insurance companies, investment companies, employee benefit plans, or an entity owned entirely by qualified investors, for example. When a broker or dealer is selling securities in reliance on rule 144A, it is subject to the condition that it may not make offers to persons other than those it reasonably believes to be QIB's.

Since its adoption, Rule 144A has greatly increased the liquidity of the securities affected. This is because institutions qualified under the Rule can now trade these formerly restricted securities amongst themselves, thereby eliminating restrictions imposed to protect the public. Rule 144A was implemented, inter alia, in order to induce foreign companies to sell securities in the U.S. Capital markets. For firms registered with the SEC or a foreign company providing information to the SEC, financial statements need not be provided to buyers. Companies issuing such restricted securities rely on secrecy and limited disclosure to protect future plans, unique trading strategies, or other business practices. Because of this need to keep operations confidential, raising capital through global exchanges that are heavily regulated and require large amounts of disclosure is a less attractive option.

Securities issued under Rule 144A, known as “144A Issues”, are becoming increasingly popular as a way for alternative asset managers such as hedge funds and private equity groups to raise permanent capital without submitting to the public disclosure requirements incumbent with the sale of stock to the general public through an initial public offering (IPO). In addition, resales of such 144A Issues in the secondary market between QIB's is also facilitated because of the reduced reporting requirements and the presumed financial sophistication of the QIB's involved.

Conventional methods and systems for effecting such sales of 144A Issues and have generally been limited to closed systems in which only one so-called “market maker” or broker/dealer and only one custodian of any physical securities involved is allowed to participate in the private marketplace.

What is needed is a market-neutral private marketplace platform in which the trading of 144A Issues may be facilitated either in the primary or secondary markets. What is further needed is a web-interfaced, computer-implemented method in which multiple broker-dealers and multiple custodians may participate.

### SUMMARY

The open platform for unregistered securities (“OPUS”) of this disclosure, in general terms, is a rules-based, multi-constituent platform for facilitating the trading and settlement of securities issued under Rule 144A of the Securities Act. The word “open” may not only mean that the platform is market-neutral, but that multiple broker-dealers and multiple custodians may participate as well. In one or more embodiments, the system includes an “open platform” capable of hosting multiple Underwriters, Issuers and Investor pools, resulting in greater liquidity of the securities. Use of a book-entry-only system and streamlined custodian component allows for quicker settlement of trades. Further, a web interface/status reporting for all users provides ease of access and use for authorized users. In addition, regulatory compliance is ensured by counting the numbers of investors involved, as well as their status. The trade is typically simultaneously booked on internal trading platforms, and flows to the OPUS platform manager through a third party trade manager, e.g., the Oasis/Omgeo system.

An overview of various aspects of embodiments of a process of this disclosure follows.

1. QIB/Investor Certification

Executed documents required from a Qualified Investment Buyer (“QIB”) include a Participation agreement and an issue-specific addendum. After execution of these agreements, the QIB is then posted to the OPUS platform as an eligible investor.

2. Slot Reservation (is there a Spot Available for a Qualified Investor?)

Does the number of beneficial holders exceed a regulatory limit? If not, then reserve a slot.

3. Security Transfer Reservation

The potential trade details are entered for matching for both the buy and sell sides of the trade.

4. Settlement (Make Required Payment to the Seller)

The OPUS platform manager matches trade reservations to Omgeo, for example, and an e-mail is sent by the platform manager to confirm share movement to both settlement areas. However, cash settlement is done directly between traders (buyers and sellers).

In one embodiment, a computer-implemented, web-interfaced method of trading and settlement of unregistered securities issued under an exception outlined in Rule 144A of the Securities Act includes providing access to a website in communication with a network, e.g., a computer network. A data structure is established and stored in a memory in one or more processors that may be arranged in one or more computers. The data structure includes information relating to one or more unregistered securities and entities involved with the trade. A trade request is received via the network from one or more interested investors pertaining to a particular one of the one or more unregistered securities. Also, a Rule 144A Qualified Institutional Buyer (QIB) eligibility status is received via the network from a compliance manager for each of the one or more interested investors. One or more eligible QIBs are determined from the QIB eligibility status information. For each of the one or more eligible QIBs, an investment slot is allocated if a number of allocated investment slots is less than a regulated value. Otherwise, and even if qualified, an investment slot is denied to any remaining qualified QIBs if the number of investment slots has been reached or exceeded. Then, an associated transfer reservation is made for each allocated investment slot before a broker/dealer makes a trade.

In another embodiment, a computer-implemented trade reservation system facilitates trade and settlement of one or more unregistered securities issued under an exception outlined in Rule 144A of the Securities Act. The system includes at least one processor in communication with a network, e.g., a computer network, and a memory operably connected to the at least one processor. The memory stores a data structure that includes information relating to one or more unregistered securities and to entities involved with the trading and settlement of the securities. One or more broker/dealers interface with the at least one computer via the network, and the one or more broker/dealer are configured to receive and process trade requests pertaining to selected ones of the one or more unregistered securities on behalf of one or more interested investors. An interface in data communication with the computer network is provided to a compliance manager. The interface with the compliance manager is configured to receive, as determined by the compliance manager, either (a) a verification of eligibility of interested investors as a Qualified Institutional Buyer (QIB) status under Rule 144A, or (2) an indication of ineligibility as a QIB for ineligible interested investors. A processor in the at least one computer is configured to allocate an investment slot to one or more eligible QIBs if a number of allocated investment slots is less than a regulated value. Otherwise, allocation of an investment slot to ineligible investors is declined. An associated transfer reservation is made for each allocated investment slot before a broker/dealer makes a trade.

In another embodiment, a computer program product for use with a computer in connection with trading and settlement of unregistered securities issued under an exception outlined in Rule 144A of the Securities Act is provided. The computer program product contains computer-readable instructions thereon which, when executed on the computer, cause the computer to interface with a network; establish a data structure stored in a memory that includes information relating to one or more unregistered securities and entities involved with the trading and settlement thereof; process trade requests from one or more interested investors pertaining to one or more of the unregistered securities; receive a Rule 144A Qualified Institutional Buyer (QIB) eligibility status from a compliance manager for each of the one or more interested investors; determine one or more eligible QIBs from the QIB eligibility status for each of the one or more interested investors; allocate an investment slot to said one or more QIBs if a number of allocated investment slots is less than a regulated value, and make a transfer reservation before a broker/dealer initiates a trade.

### BRIEF DESCRIPTION OF THE DRAWINGS

Various embodiments of the disclosure will now be described, by way of example only, with reference to the accompanying drawings in which:

FIG. 1A provides a notional block diagram of the unregistered security trade reservation system of an embodiment of this disclosure;

FIG. 1B provides a block diagram illustrating a further aspect of the embodiment of FIG. 1A;

FIG. 1C illustrates an aspect of a structured database of an embodiment of this disclosure;

FIG. 1D illustrates another aspect of a structured database of an embodiment of this disclosure;

FIG. 1E illustrates another aspect of a structured database of an embodiment of this disclosure;

FIG. 2A provides a flowchart of an embodiment of a trade processing method of this disclosure with respect to an implementation/maintenance process;

FIG. 2B provides a flowchart of an embodiment of a trade processing method of this disclosure with respect to a trade process;

FIG. 2C is a continuation of the process of FIG. 2B;

FIG. 2D is a continuation of the process of FIG. 2C;

FIG. 2E provides a flowchart of an embodiment of a trade processing method of this disclosure with respect to a proof/transfer/reconciliation process;

FIG. 2F is a continuation of the process of FIG. 2E;

FIGS. 3A and 3B compare various interactions of the system and method when there is a single custodian and when there are multiple custodians;

FIG. 4 provides an exemplary screen shot of a landing page after successful authentication of a login by a user;

FIG. 5 provides an exemplary screen shot of a QIB/Issue Cross Reference page from which a Broker/Dealer can reserve a spot, or reserve a trade;

FIG. 6 provides an exemplary screen shot of a slot request confirmation screen presented to a user after a slot reservation has been made;

FIG. 7 provides an exemplary screen shot of a trade reservation for a selling QIB that allows a Broker/Dealer to enter a trade reservation on behalf of a QIB;

FIG. 8 provides an exemplary screen shot of a confirmation of a trade reservation;

FIG. 9 provides an exemplary screen shot of a pending trades screen that presents the user (broker/dealer or QIB) with a list of pending trades which need approval;

FIG. 10 provides an exemplary screen shot of a confirmation of trade approval screen;

FIG. 11 provides an exemplary screen shot of an issue details screen that lists issues managed on the system of this disclosure, including important spot maximums, last trade information, and links to issue documents;

FIG. 12 provides an exemplary screen shot of an issue document list that provides access to documents for every issue;

FIG. 13 provides an exemplary screen shot of a transaction list that is filterable by issue and QIB;

FIG. 14 provides an exemplary screen shot of a custodian transaction detail report;

FIG. 15 provides an exemplary screen shot of a custodian position report;

FIG. 16 provides an exemplary screen shot of an issuer slot approval/denial screen;

FIG. 17 provides an exemplary screen shot of an administrative user task panel;

FIG. 18 provides an exemplary screen shot of a market maker administrative profile function;

FIG. 19 provides an exemplary screen shot of a market maker administrative relationship function;

FIG. 20 provides an exemplary screen shot of an issuer administrative profile function;

FIG. 21 provides an exemplary screen shot of an issuer administrative relationship function;

FIG. 22 provides an exemplary screen shot of an issue administrative profile function;

FIG. 23 provides an exemplary screen shot of an issue administrative relationship function;

FIG. 24 provides an exemplary screen shot of an investor administrative profile function;

FIG. 25 provides an exemplary screen shot of an investor administrative relationship function;

FIG. 26 provides an exemplary screen shot of a custodian administrative profile function;

FIG. 27 provides an exemplary screen shot of a custodian administrative relationship function;

FIG. 28 provides an operational workflow diagram of an exemplary sell trade reservation process of an embodiment; and

FIGS. 29-1 to 29-3 provide a logical data model relating to an exemplary data architecture of an embodiment.

### DETAILED DESCRIPTION

Various definitions of terms in Table I below are used throughout this disclosure and may be useful in understanding the following description of the method and system of this disclosure.

TABLE I
Definition of Terms

| Term | Definition |
|---|---|
| Issuer | Contracts with Trade Platform Manager for transfer agent (TA) |
| | services and assure that issue-specific requirements, such as the |
| | maximum number of investors, are maintained. |
| Market Maker | Underwrite the issue's initial offering and its traders will actively |
| | work trades for the issue after the initial closing. Typically, a |
| | market-maker has the power to set buy and sell prices for a |
| | security. |
| Qualified Institutional | In law, a Qualified Institutional Buyer is a purchaser of |
| Buyers (QIBs) | securities that is financially sophisticated and is legally |
| | recognized by security market regulators to need less protection |
| | from sellers than most members of the public. |
| | These institutions, that manage at least $100 million in securities, |
| | include banks, savings and loans institutions, insurance |
| | companies, investment companies, employee benefit plans, or an |
| | entity owned entirely by qualified investors. |
| Custodian | Must be associated with and involved in any QIB transaction in |
| | an issue. |
| Broker/Dealer | Involved in bringing trades to the reservation system once the |
| (“B/D”) | initial offering is completed. |
| API | Application Programming Interface |
| Trade information | Messaging facility that automatically communicates trade |
| messaging system | information entered into a Broker Dealer trading system to the |
| | various interested parties of a trade. For example, a trade |
| | manager may learn of trades via communication through a service |
| | provider such as Omgeo ® or Omgeo Oasys ®. An ID trade |
| | confirmation is received for both the buy and sell sides of a trade. |
| Platform Manager/Trade | The entity that “owns”, i.e., controls and manages, a trade |
| Facilitator | reservation software, and hosts or controls hosting of the trade |
| | reservation system website. |

There are various entities involved with setting up and executing trades using the system and method of this disclosure. For example, in one embodiment, the Issuer contracts with the Trade Platform Manager for transfer agent services and assurance that issue-specific requirements, such as the maximum number of investors, are maintained. An investment bank will underwrite the issue's initial offering, and a market maker will actively work trades for the issue after the initial closing. Entities allowed to invest in the issue are limited to Qualified Institutional Buyers (“QIB”), as defined above. A QIB's custodian(s) is another entity that must be associated with and involved in any QIB transaction in an issue. Finally, broker/dealers who were not part of the original underwriting will likely be involved in bringing trades to the trade reservation system once the initial offering is completed.

In addition, securities issued under Rule 144A (“Rule 144A Issues” or “Issues”) are not Depository Trust Corporation (“DTC”) eligible, so that the trade platform of at least one aspect of this disclosure replicates DTC's known role in the public market place. Further, multiple custody relationships are supported.

Other than known Transfer Agent functions, a platform to support a private 144A marketplace has unique requirements which differ from the traditional Transfer Agent role. For example, because the issues being serviced by the trade reservation platform of this disclosure cannot trade on an open public market, traded issues are not Depository Trust Corporation (DTC) eligible, therefore the proposed platform must replicate DTC's role in the public marketplace. Further, in contrast to the conventional approaches, and to ensure a truly “open” platform, multiple custody relationships and multiple broker/dealers must be supported. In order to avoid triggering Exchange Act reporting requirements for any listed company, the platform will need to ensure that the ownership base of any company is less than 500 shareholders (“QIBs”) for U.S. securities, and less than 300 U.S. QIBs if the issue is a foreign, non-U.S. security. As mentioned above, investors are limited to QIB's, but additional transfer and ownership restrictions may be placed by the Issuer. In any event, trading will require “reserving a slot” and making a security transfer reservation via the trade reservation system of this disclosure.

In one embodiment, a “front-end” slot and transfer reservation system interfaces with a conventional Transfer Agent system. In one aspect of this embodiment, the system provides access for at least the entities described above, as well as the trade platform manager's internal operations personnel. In addition, a “back-end” component of the trade reservation system provides the ability to electronically settle trades in the core Transfer Agent system. This may be done by matching trade reservations made in the front-end to trade details entered in the various market makers' trading systems, and communicated to the platform manager through the trade information messaging system.

In another aspect, the front-end provides web-based reporting as appropriate to the various entities involved with the trade, taking advantage of the ability of the core Transfer Agent system to count investors, assuring that no more than a specified number of investors, as determined by the issuer, are active at any one time in an issue, and establishing the relationship of the investment to the master QIB agreements, custodians, and broker/dealers.

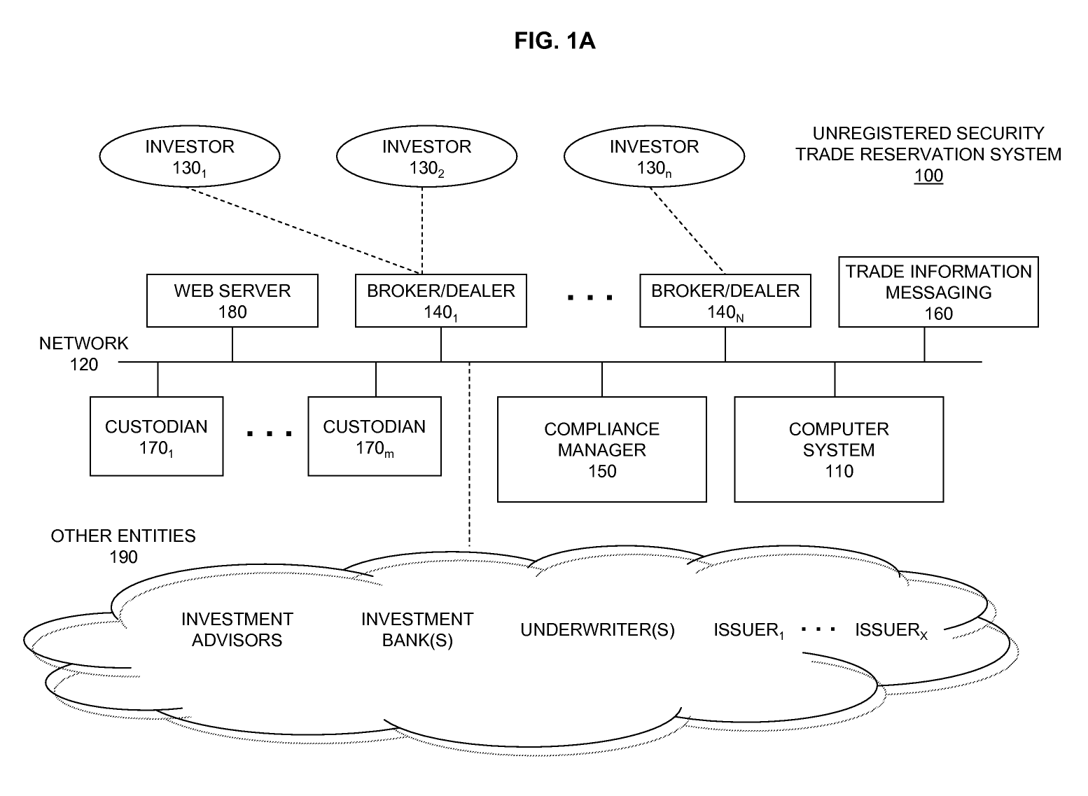

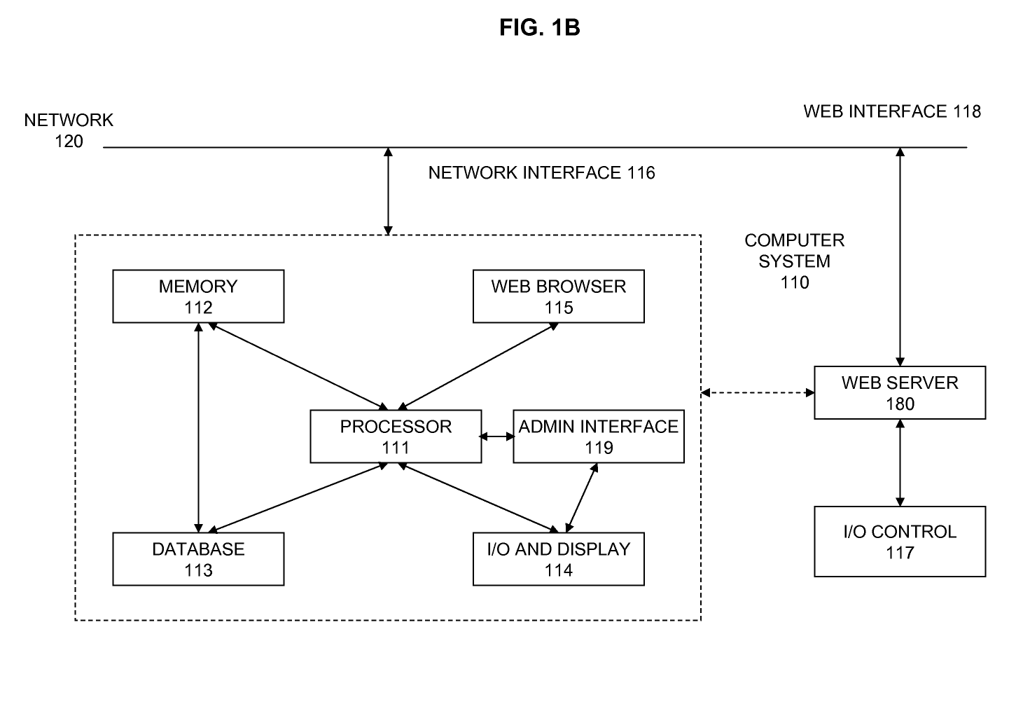

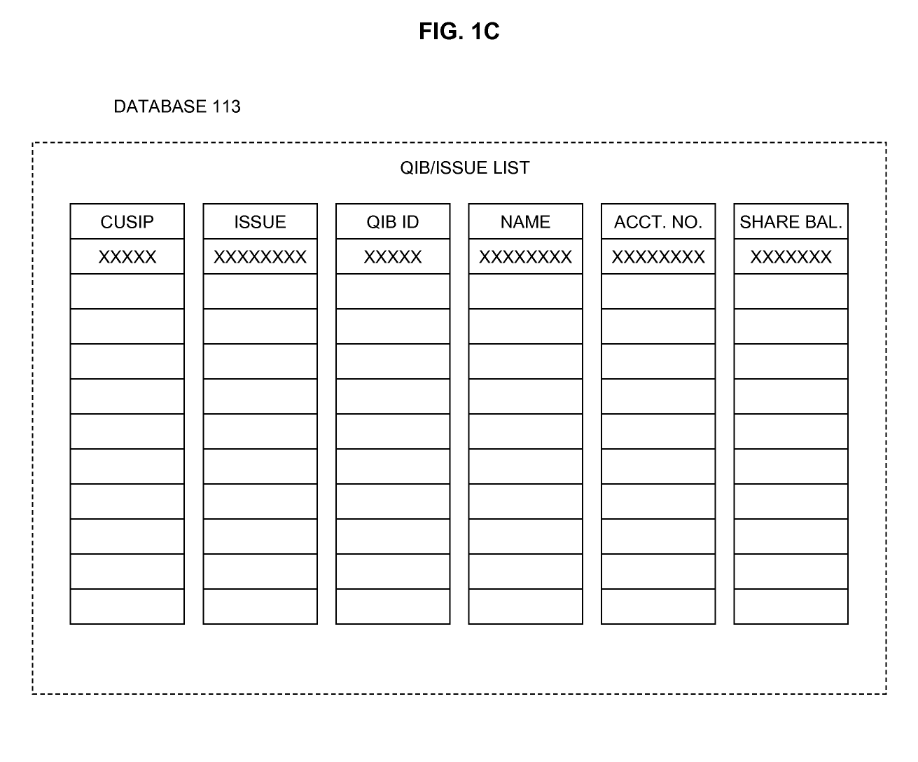

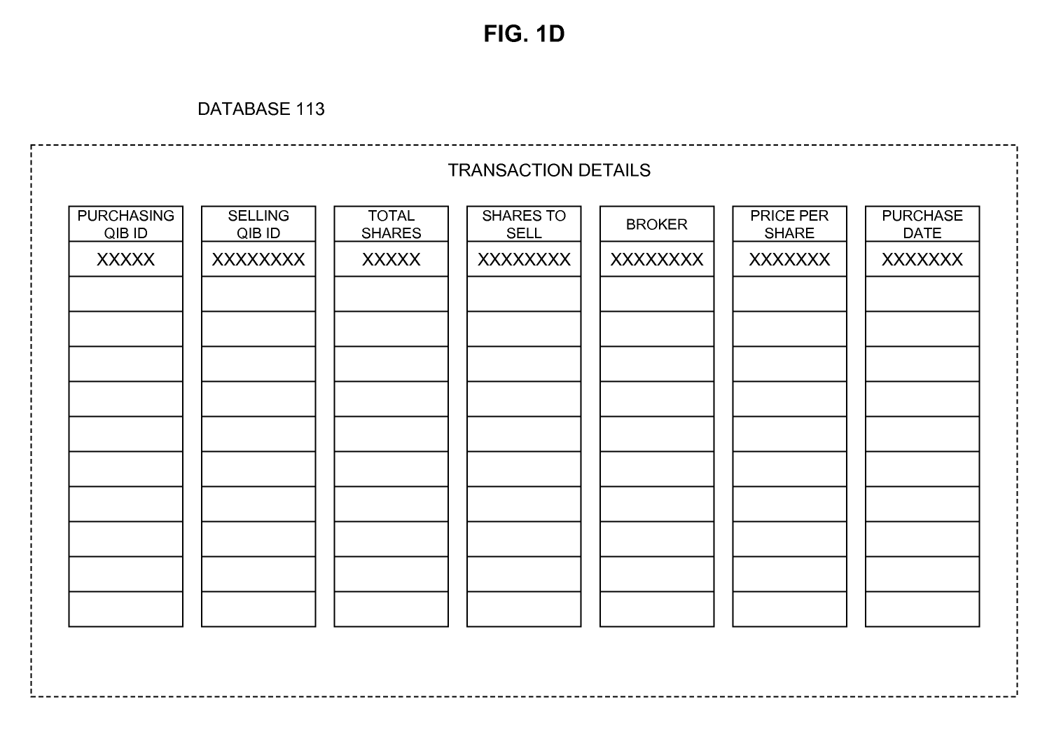

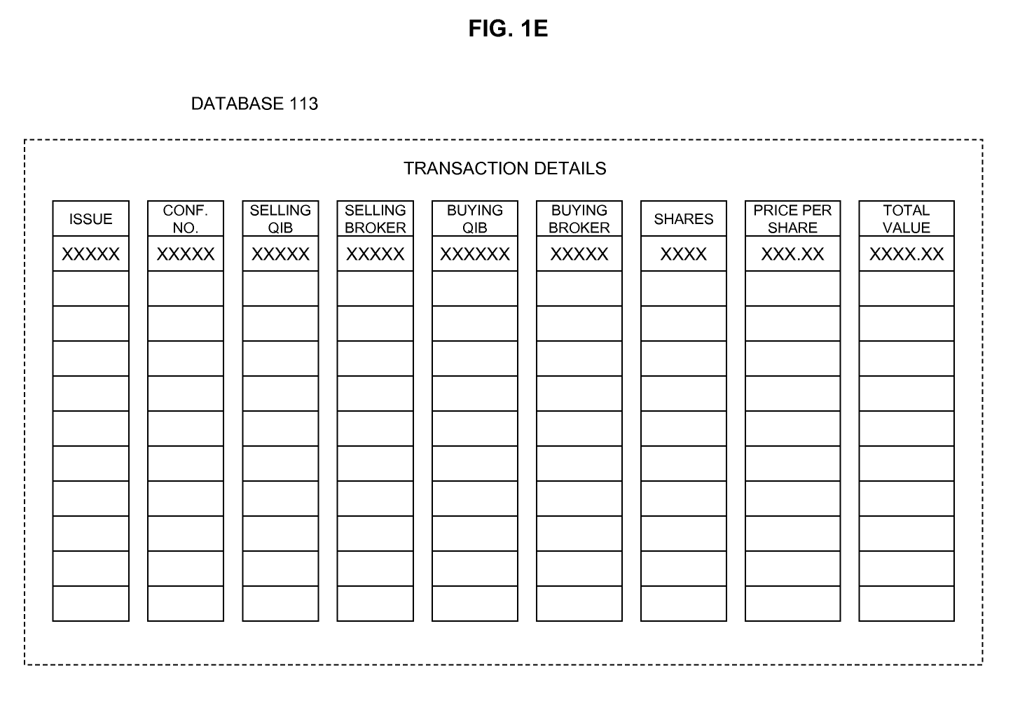

An exemplary unregistered security trade reservation system 100 is depicted in block diagram form in FIG. 1A. Computer system 110 is connected to network 120, and is configured to run software that carries out the various functions of the system, as discussed further below. Network 120 may include a local area network (LAN) and/or the internet. One or more investors 130₁-130ₙ (n≧1) access computer system 110 via one or more broker/dealers 140_{N} (N≧1) which are registered with the manager of unregistered security trade reservation system 100.

Compliance Manager 150 provides validation and/or certification that one or more of the investors 130n is eligible for QIB status in accordance with SEC regulations. Compliance Manager 150 may either be a third party system such as provided by, e.g., Dealogic, LLC, or it may be under the direct control of the manager of unregistered security trade reservation system 100. In either case, Compliance Manager 150 may include a database that stores QIB status information relating to various investors. In one embodiment, Compliance Manager 150 may simply be a person or persons who use manual or semi-automated techniques to determine the eligibility for QIB status for various interested investors.

Trade information and messaging subsystem 160 may provide automated notification of trade messages between the seller, buying broker/dealers, and the trade reservation platform manager, for example. Such functionality may be provided by a third party, e.g., the commercially available Omgeo Oasys (“Omgeo”) messaging system, interfaced with system 100 via network 120.

After the trade is executed, one or more custodians 170ₘ, (m≧1) could be involved in maintaining custody by physical maintenance of issued shares, or by maintaining “virtual” custody of issues that use a book-entry system of stock transfer. Each QIB may have their own preferred custodian or sub-custodian for either physical or book-entry shares, or custody may be held “in-house”, with out-of-bank assets messaging with a third party custody bank of QIBs.

Bi-directional access to computer system 110 may be directed through web server 180 in an embodiment where network 120 is the internet or other publicly accessible network. Other entities 190 that may interface directly or indirectly with system 100 with respect to a particular trade include investment banks, underwriters, and one or more issuers. Other entities that may interface with system 100 for informational purposes include investment advisors, for example.

FIG. 1B provides additional details relating to an embodiment of computer system 110 and associated components and subsystems. Computer system 110 may include a processor 111 operatively connected to memory 112, a database 113, input/output (I/O) and display components 114, and web browser software executed by processor 111, for example. Display of information by I/O and display components 114 may be by a graphical user interface (GUI) such as Windows®, for example. Computer system 110 may connect to network 120 through a known network interface 116. Web server 180 may be a standalone computer and related peripherals that operate a website through web interface 118, or website functionality may be incorporated into computer system 110. Administrative and maintenance functions generally associated with maintaining a website may be carried out through known input/output available through I/O control 117, for example. Administrative interface 119 may be incorporated to provide particular functionality beneficial in the processing of trades, and examples of such functionality, generally implemented by computer software, is discussed in greater detail below.

Database 113 may be a structured database configured to store various types of information associated with the entities associated with one or more particular trades, as well as information relating to the issues being traded. For example, FIGS. 1C through 1E illustrate various types of information that may be stored in a structured manner in database 113. The database may beneficially be structured to store data in a unique manner to facilitate various aspects of trading in Rule 144A Issues, e.g., the structured storage of unique data relating to the potential participation in one or more trades by multiple broker/dealers, multiple issuers, and/or multiple custodians.

In FIG. 1C, the acronym “CUSIP” typically refers to a 9-digit alphanumeric security identifier distributed by the “Committee on Uniform Security Identification Procedures” and operated by Standard and Poor's for all North American security issues for the purposes of facilitating clearing and settlement of trades. In FIG. 1C, for example, an issue identified by particular CUSIP number may be associated with a particular QIB (i.e., an approved investor 130), account number, and share balance. As illustrated in FIG. 1D, transaction details may be stored and linked together in structured database 113. Transaction details may also be stored and linked together in database 113 in the manner depicted in FIG. 1E.

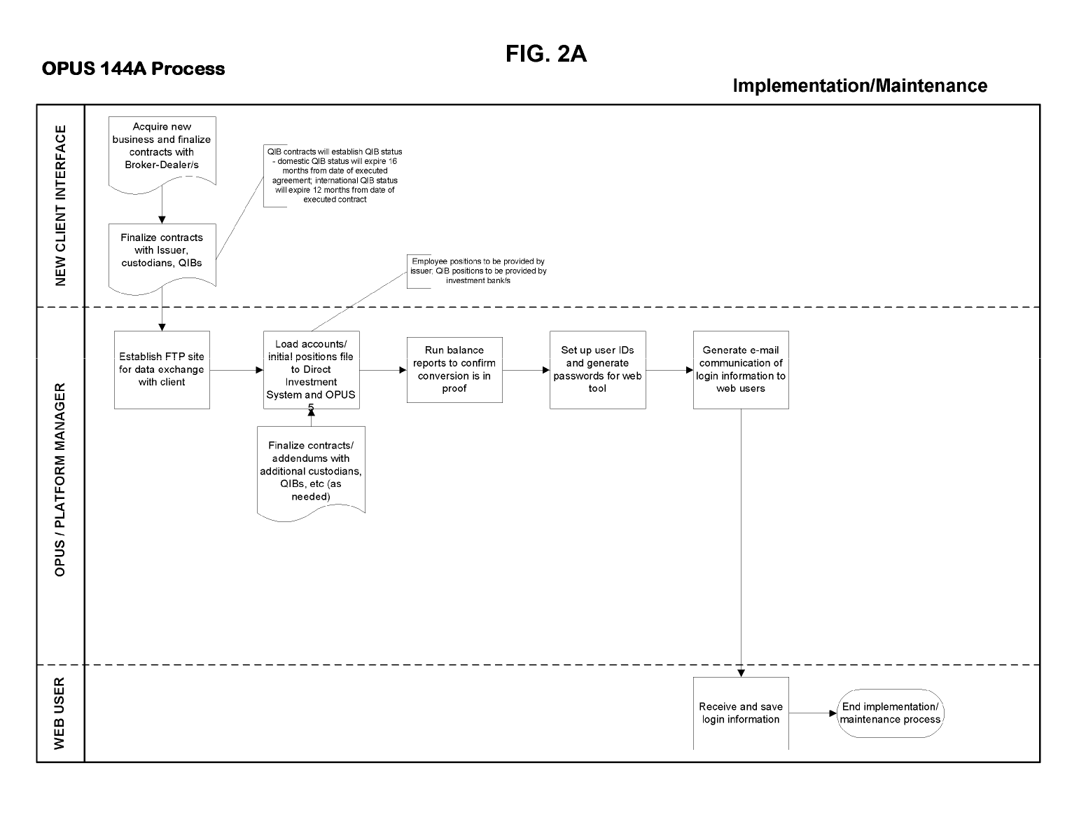

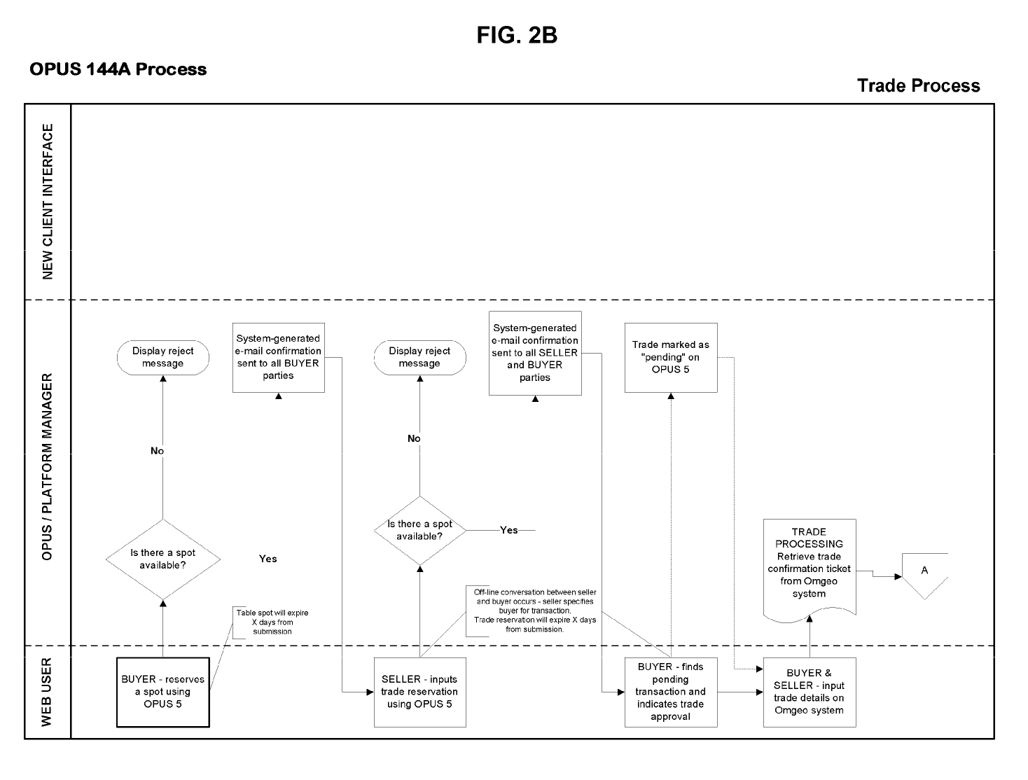

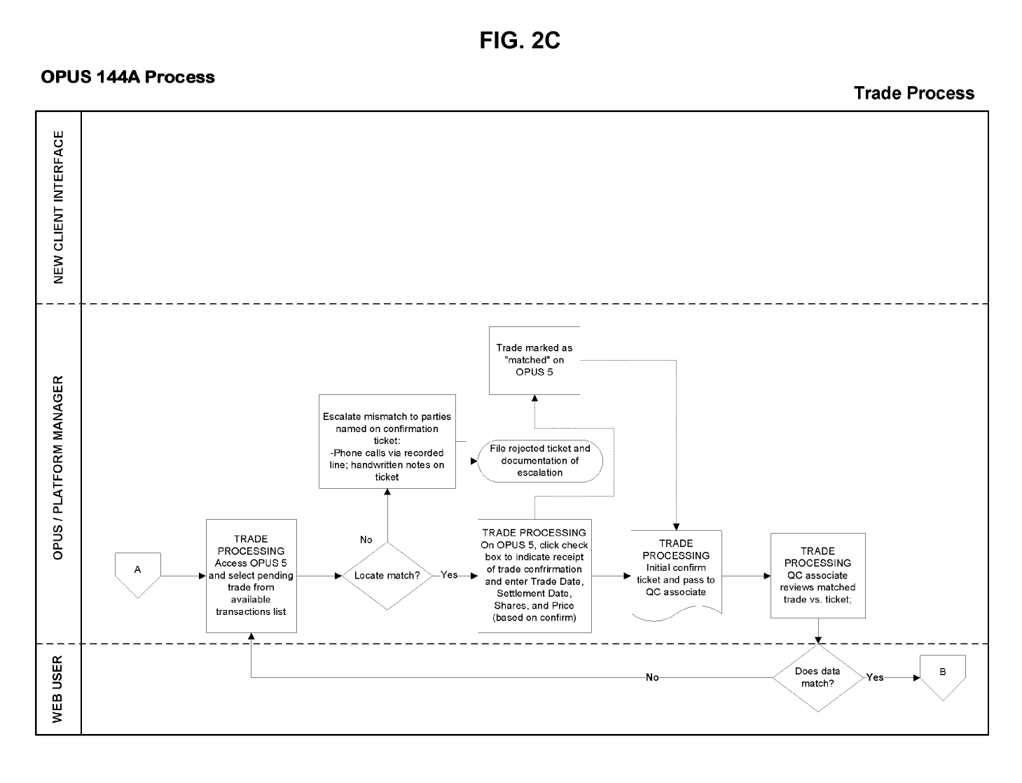

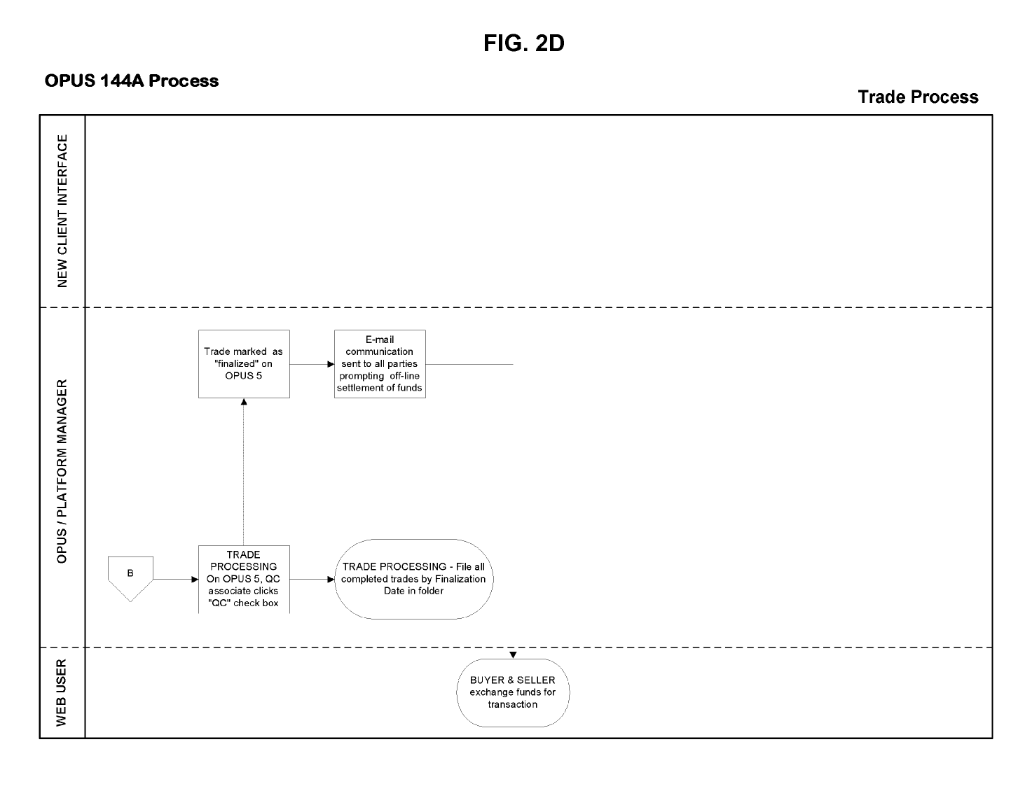

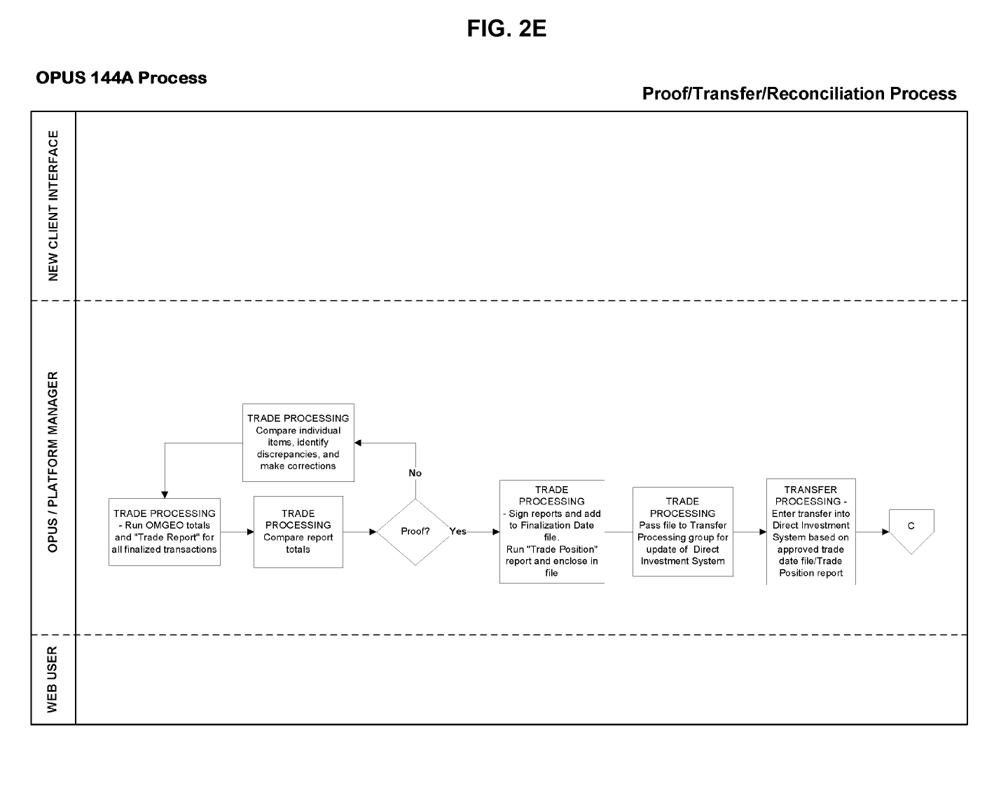

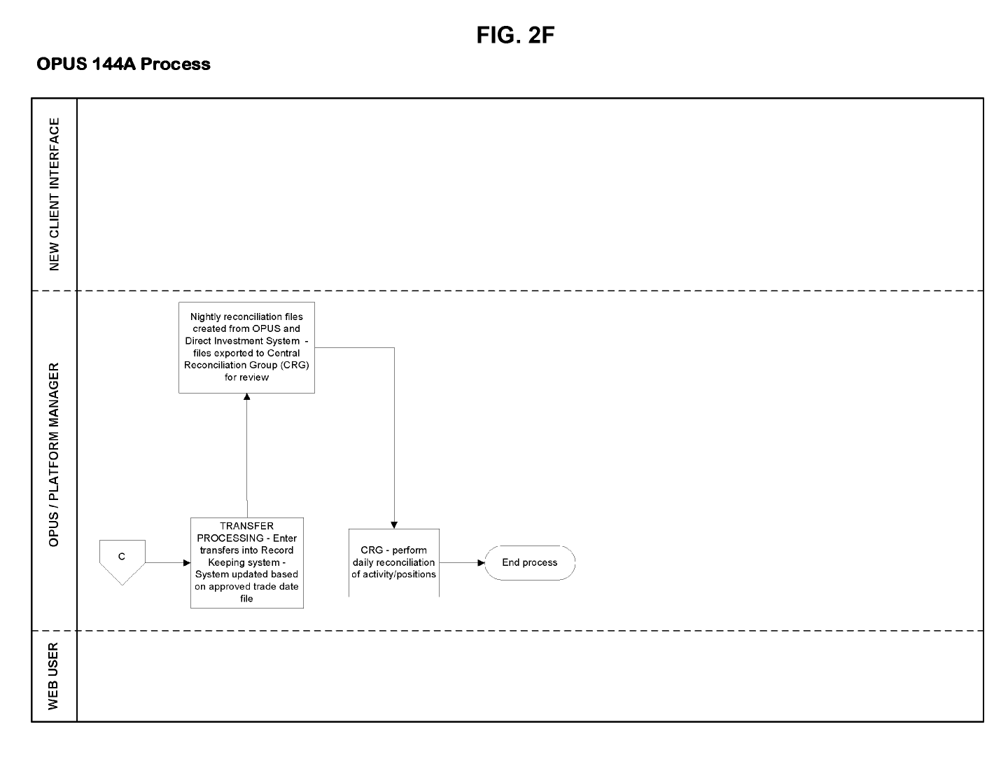

A simplified process flow of an embodiment showing possible actions of various entities associated with a trade is illustrated in FIGS. 2A through 2F. Initially, as depicted in FIG. 2A, arrangements are made with clients, i.e., entities desiring use of the OPUS system such as Issuers, Custodians, and QIBs, for example. To facilitate the exchange of information, a file transfer protocol (FTP) site may be established with one or more of the entities involved with the facilitation of trades. Administrative details of the various accounts associated with the various entities may also be implemented in OPUS, including login and e-mail information.

In the example of FIGS. 2B-2D, when a trade is contemplated, the OPUS system determines whether a trade slot is available in response to a qualified buyer, i.e., a QIB, reserving a trade slot via secure web/internet access to OPUS. In response to one or more trade slot reservations, a qualified seller may input one or more trade reservations via a secure web interface to OPUS. Respective buyers would be made aware of the pending transaction, and would indicate approval of the trade. The buyer and seller would, separate from the OPUS system, input trade details into a trade information messaging system, e.g., the third party Omgeo system or equivalent. OPUS would then receive a trade confirmation “ticket” from the Omgeo system via a web interface, for example. The OPUS system would then match the confirmed trade with a listing of available transactions stored in the OPUS system, and cause appropriate communication to occur with the parties involved in the event either of a match or of a mismatch. In the event of a mismatch between a trade message received and an OPUS transfer reservation, OPUS may communicate with the brokers involved to break a trade.

Communication of a match or mismatch may be via e-mail, for example, or other conventional means. The communication may also be used to prompt off-line settlement of funds between the buyer and seller. It should be noted, however, that settlement of finds is conducted outside of the OPUS system.

FIGS. 2E-2F illustrate an example of how trade proof, transfer, and reconciliation may be carried out by OPUS. From this process, various reports may be generated for buyers, seller, and custodians, for example.

As a further overview example of a trade process using OPUS system 100, and with reference to FIG. 1, broker/dealer 140 matches a potential buyer/seller outside the system 100. Then, broker/dealer 140 queries the platform manager/trade facilitator of system 100 for one or more trade spots and seller's shares via system 100, for example. The platform manager or trade facilitator may then determine whether a buyer QIB ID exists in the system, and whether there is a trade slot available for the buyer. If so, then a seller could provide an indication of a transfer reservation to system 100 via the web interface that would indicate that a seller has shares available. If shares are available as evidenced by a transfer reservation made by a seller, then broker/dealer 140 may initiate a trade via the trade information messaging subsystem 160, which, in one or more embodiments, sends trade messages to one or more of the seller, buying broker/dealer, and platform manager/trade facilitator. It should be noted that while trade information messaging subsystem 160 is indicated as forming a part of OPUS system 100, it may, in one or more embodiments, be a separate entity from the OPUS platform manager, and may be completely separate from system 100. Thus, in one or more embodiments, the trade initiated by broker/dealer 140 may be initiated completely outside system 100. In this circumstance, OPUS system 100 is a platform that merely facilitates the outside trading. In any event, and assuming that there is a validated or confirmed buying QIB, and that the seller has available shares, the trade is consummated by the participating broker/dealers outside of the OPUS system 100.

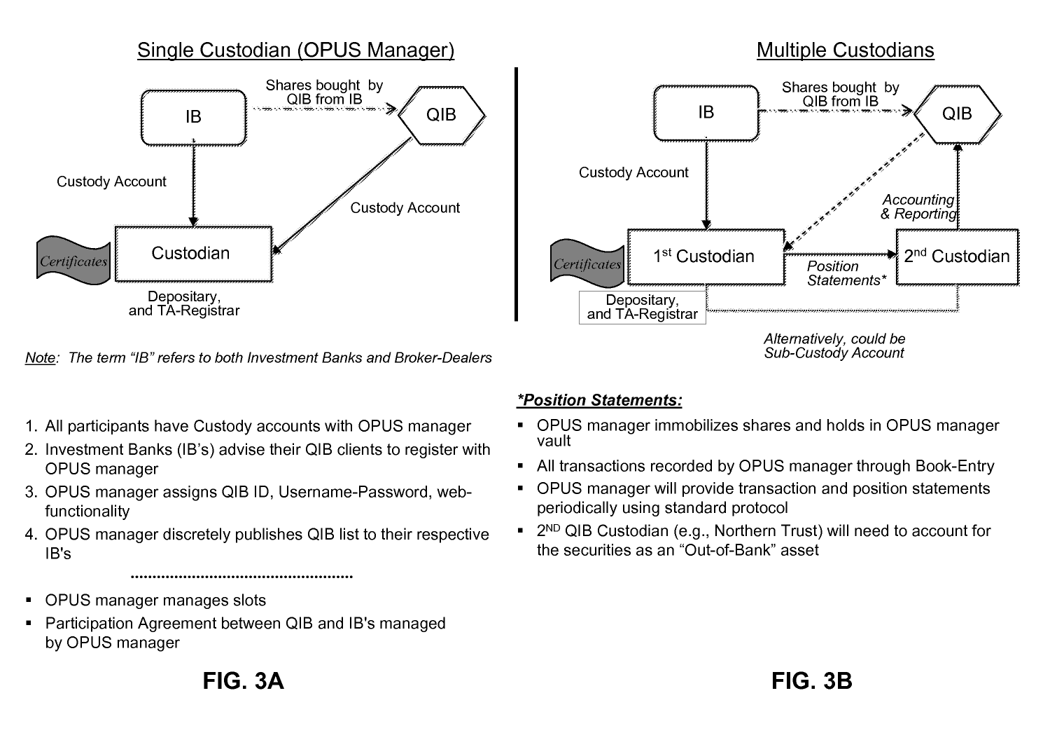

FIGS. 3A and 3B respectively illustrate situations where either a single custodian or multiple custodians are involved with managing custody after the trade has completed.

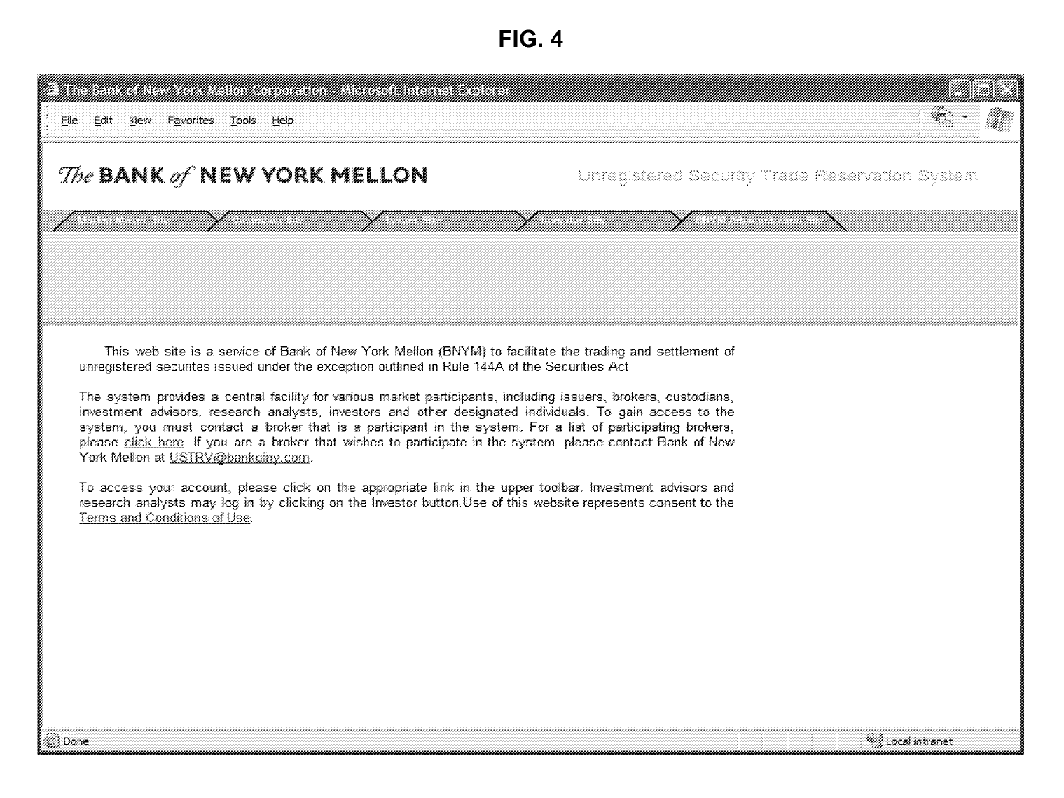

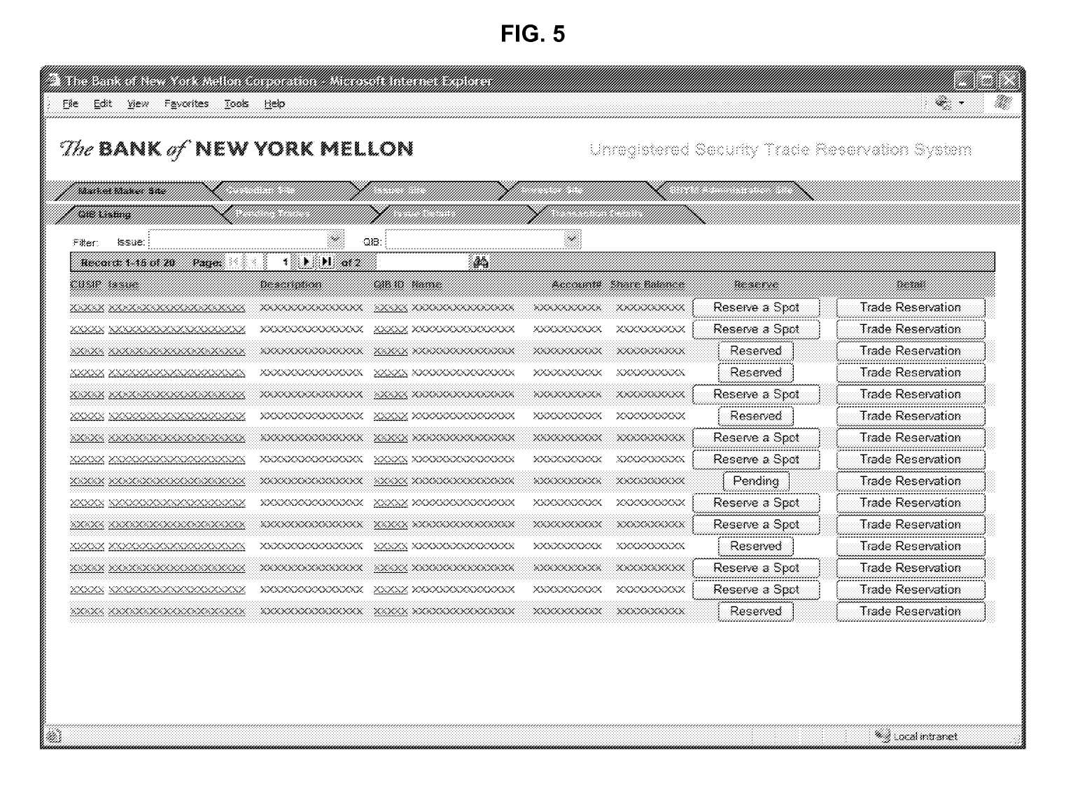

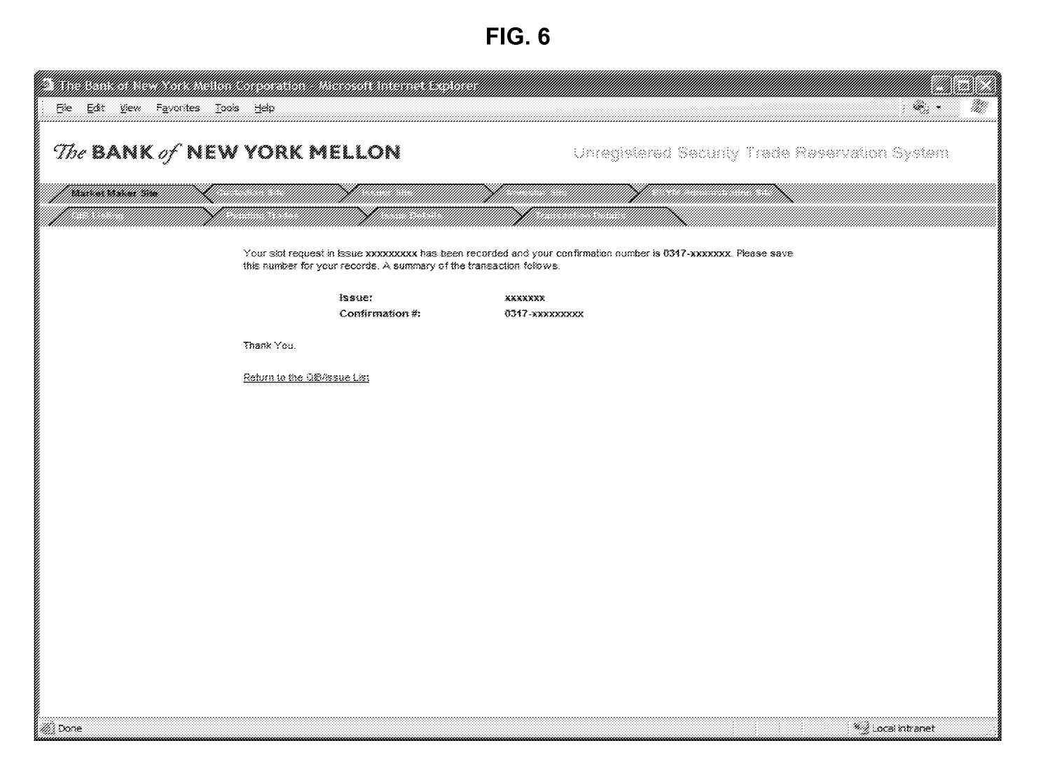

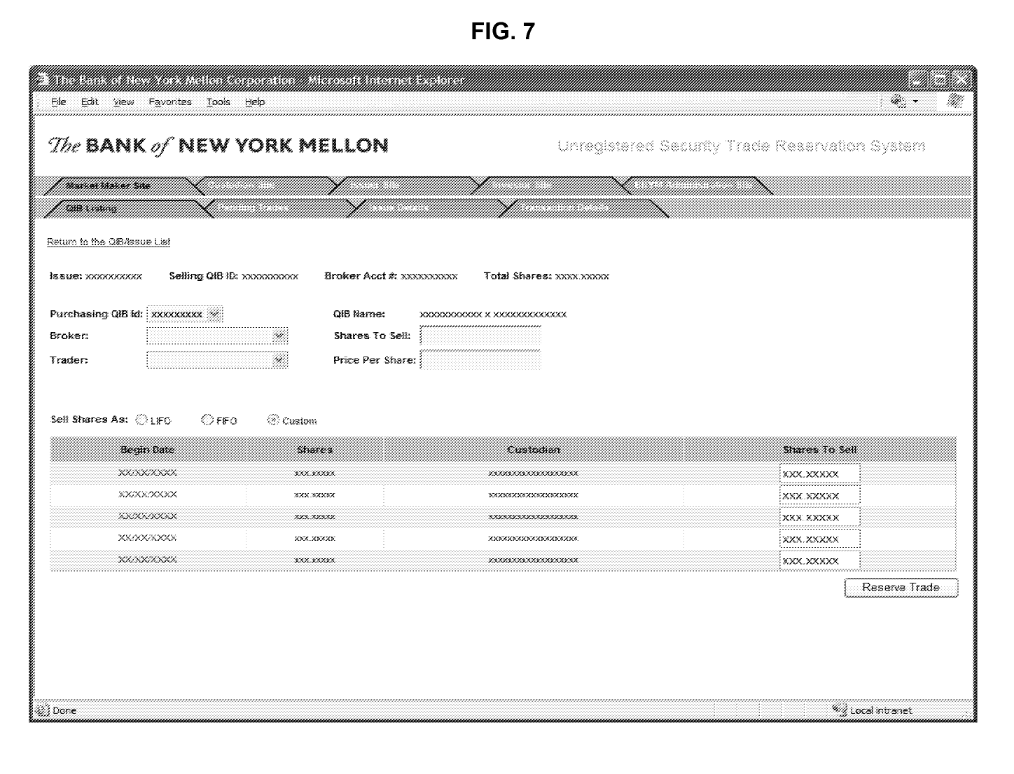

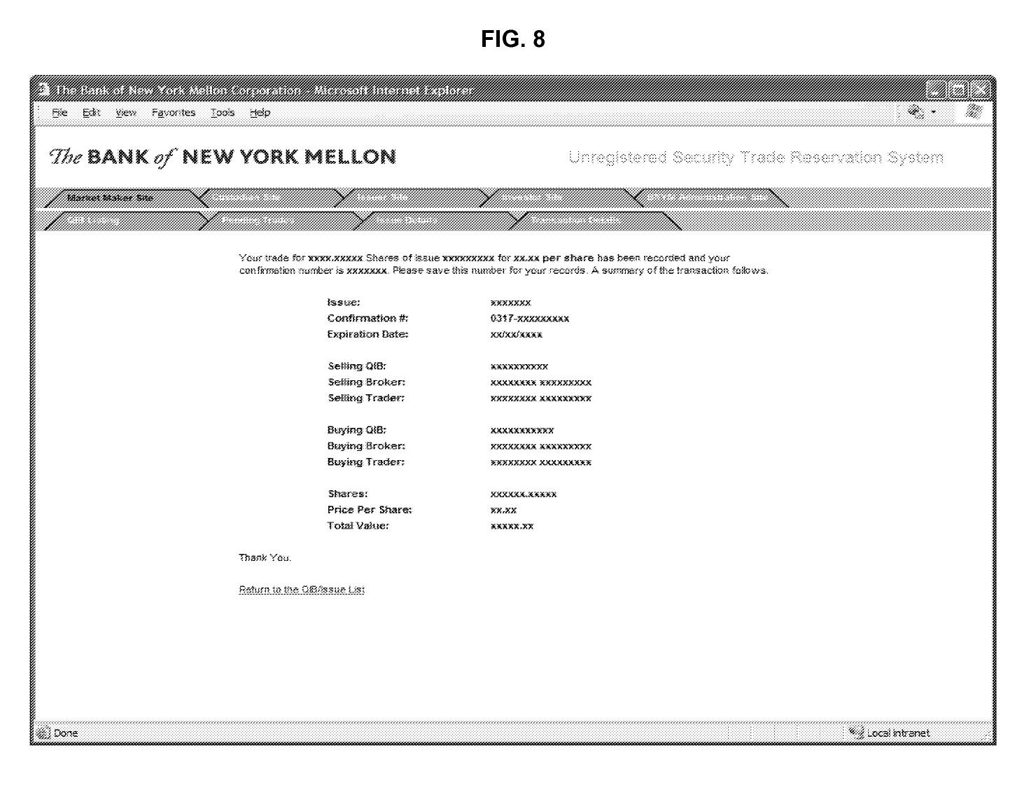

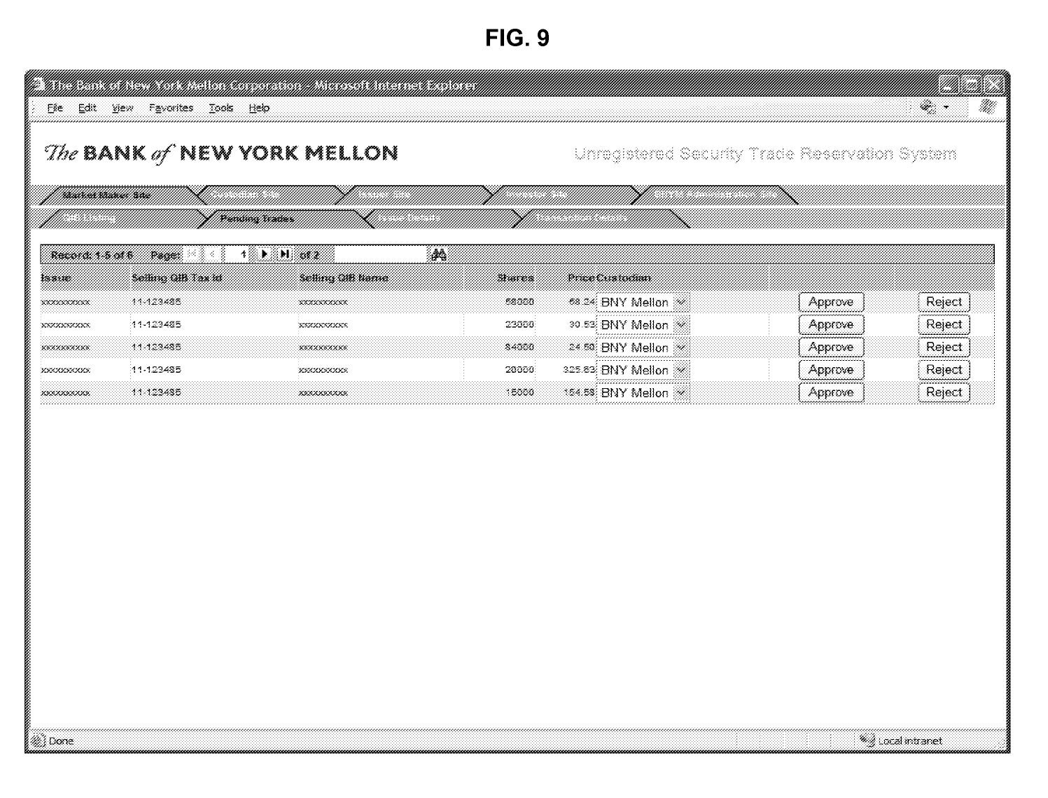

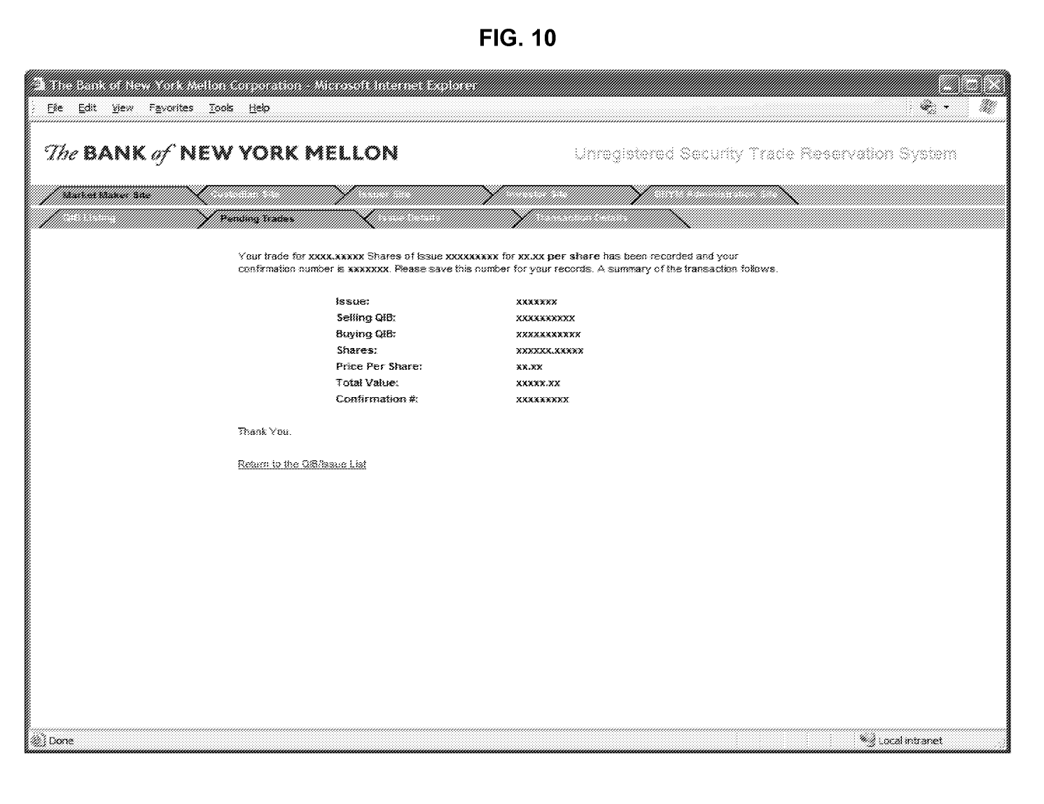

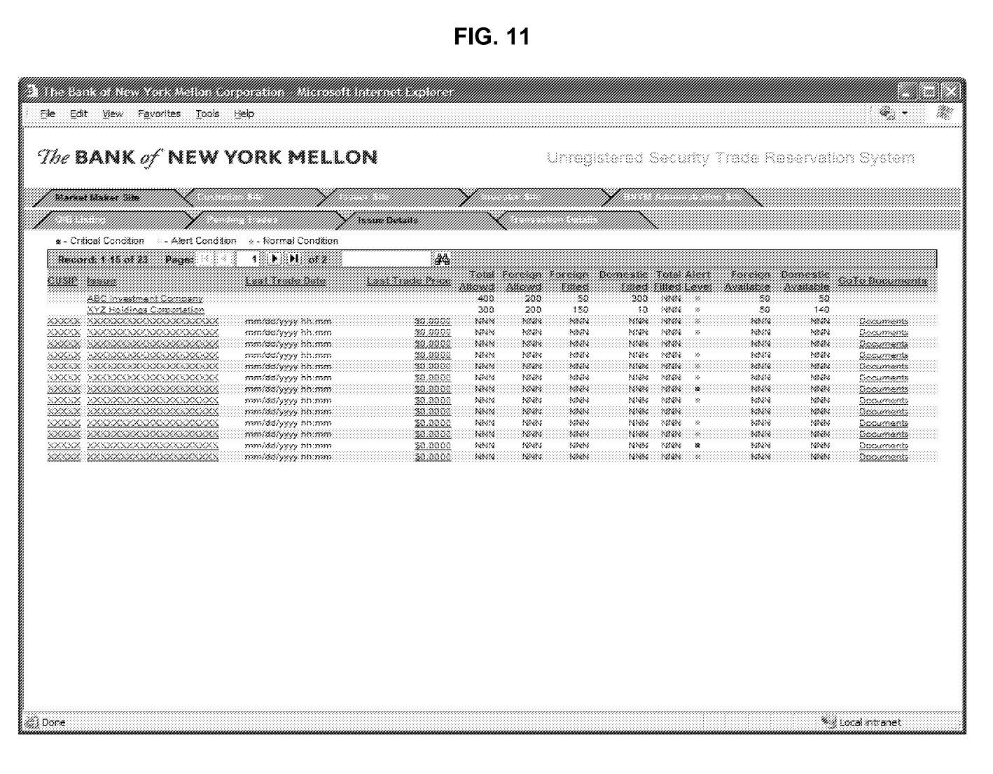

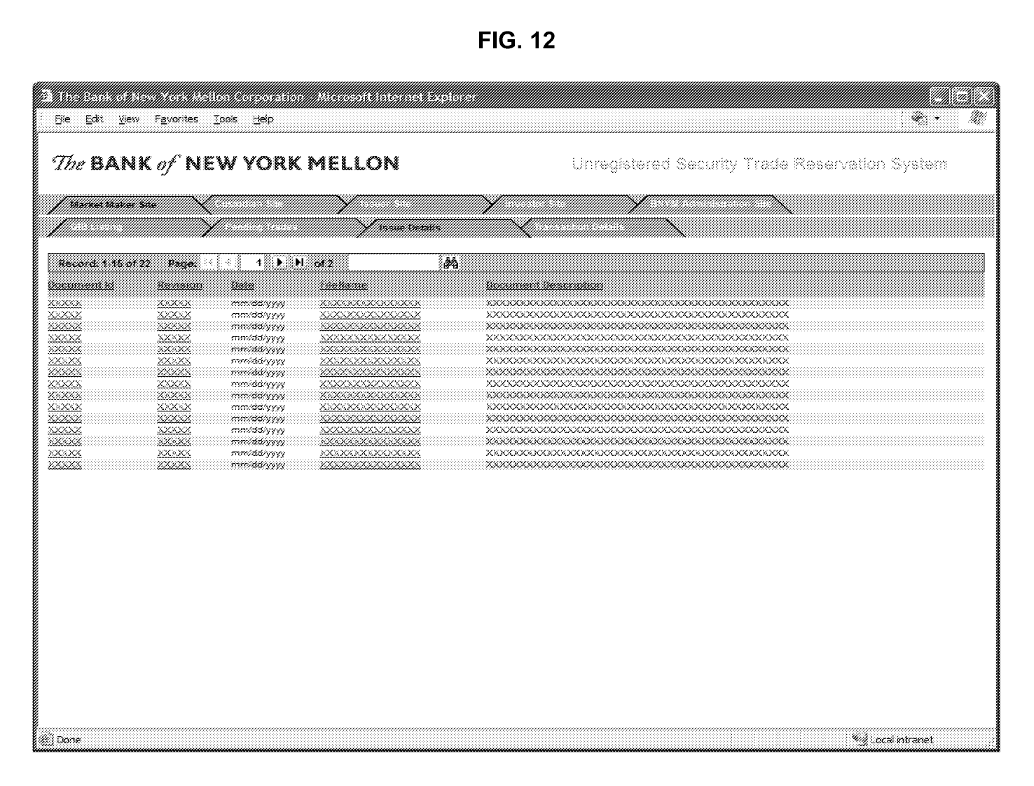

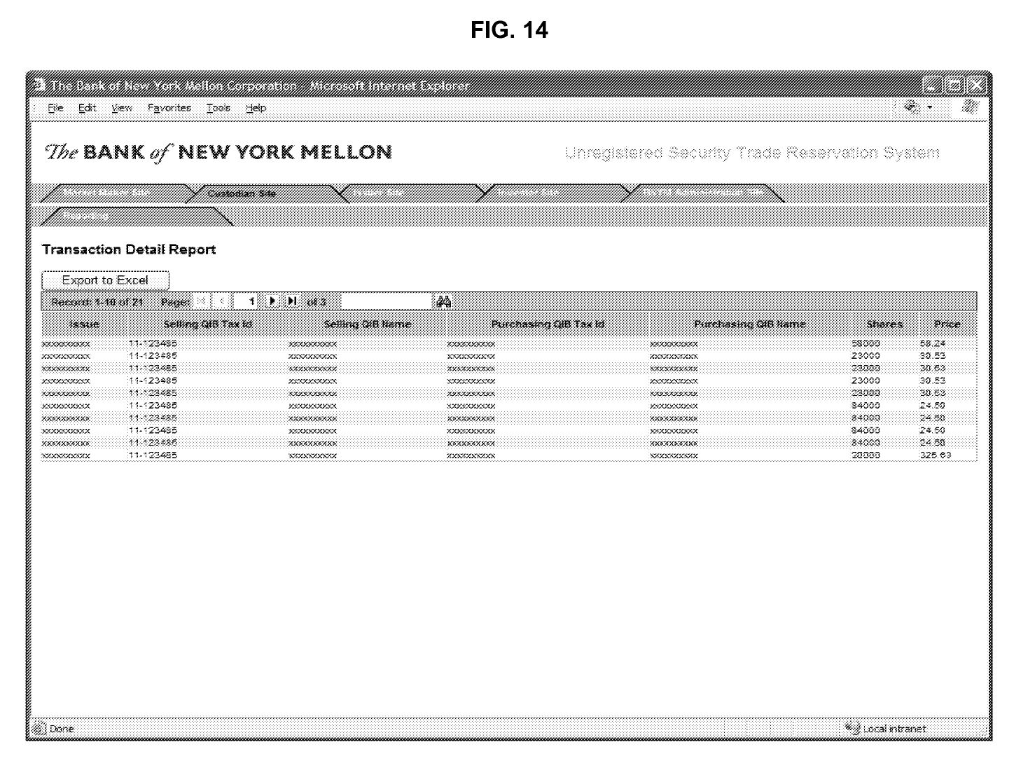

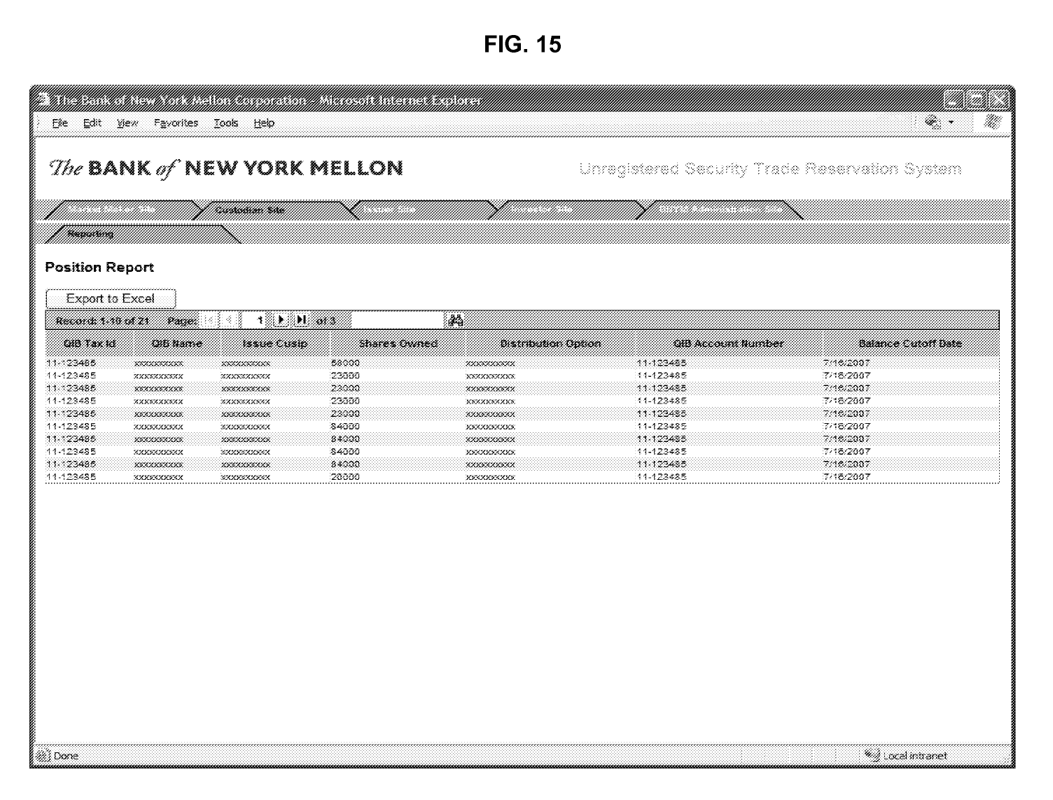

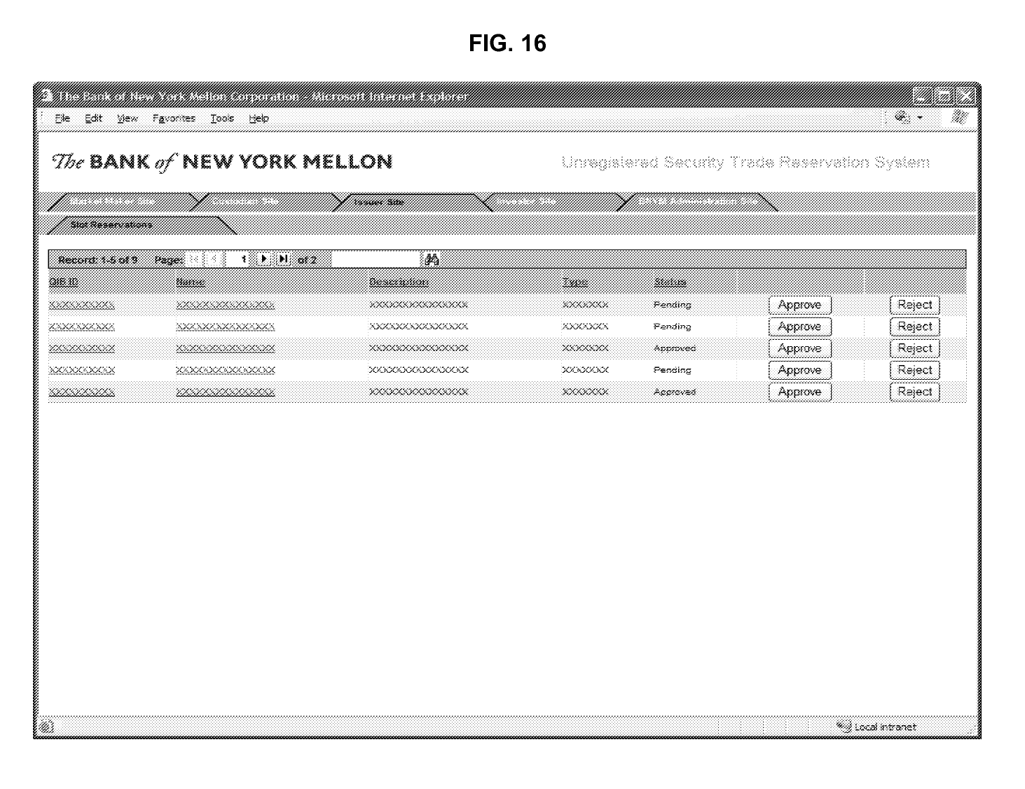

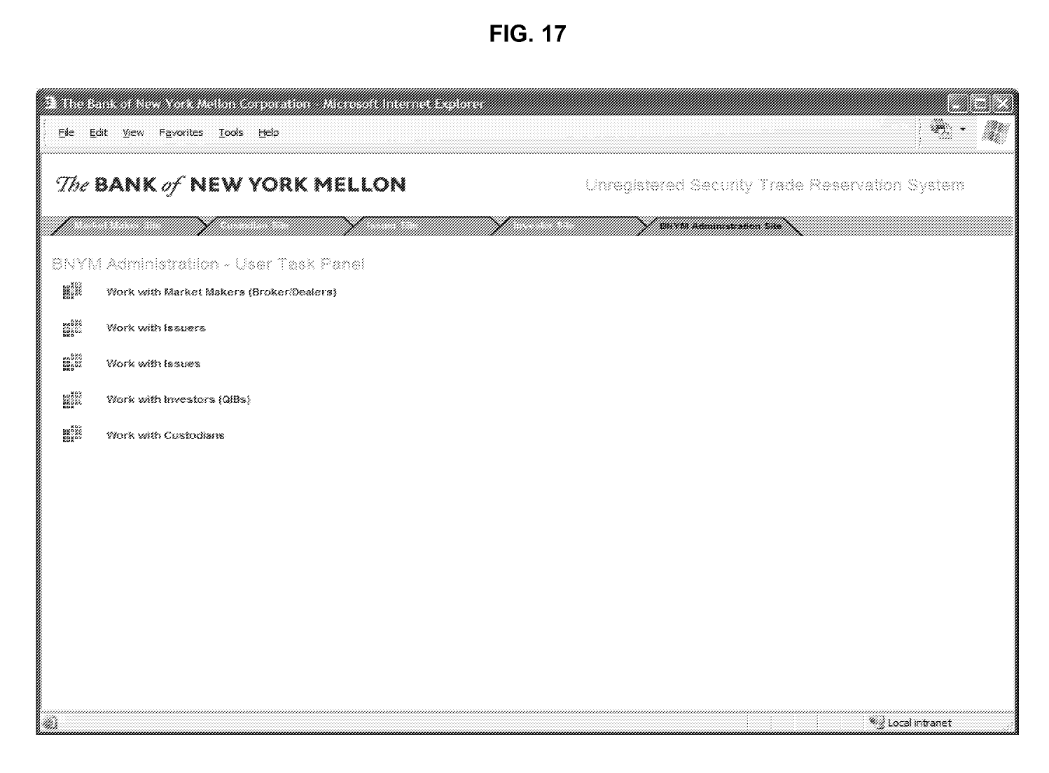

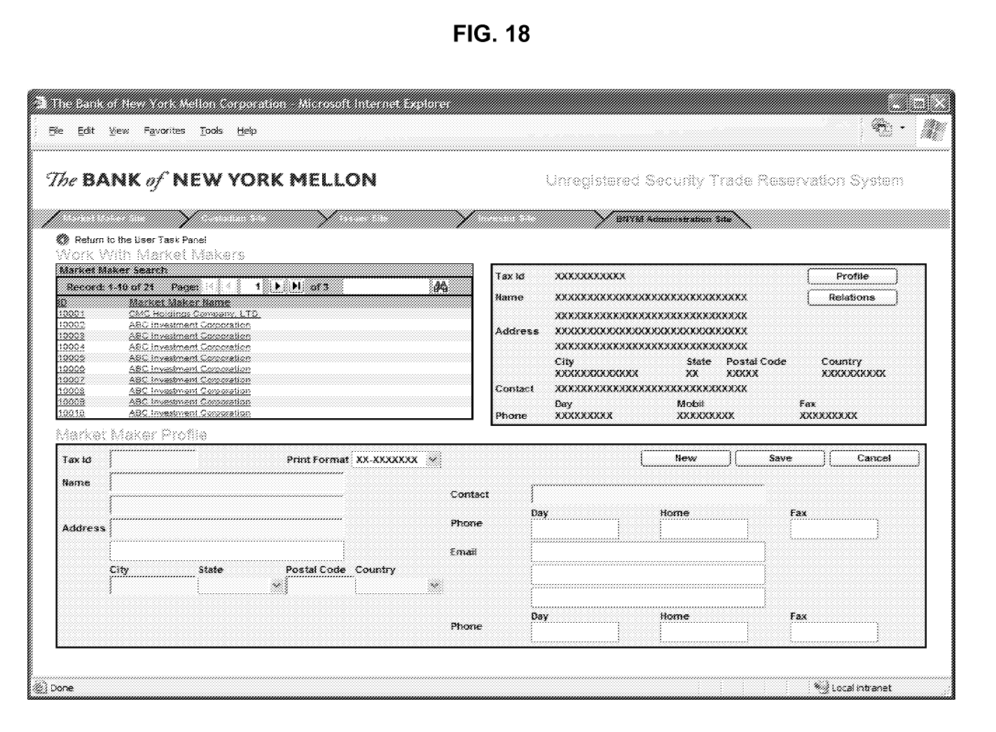

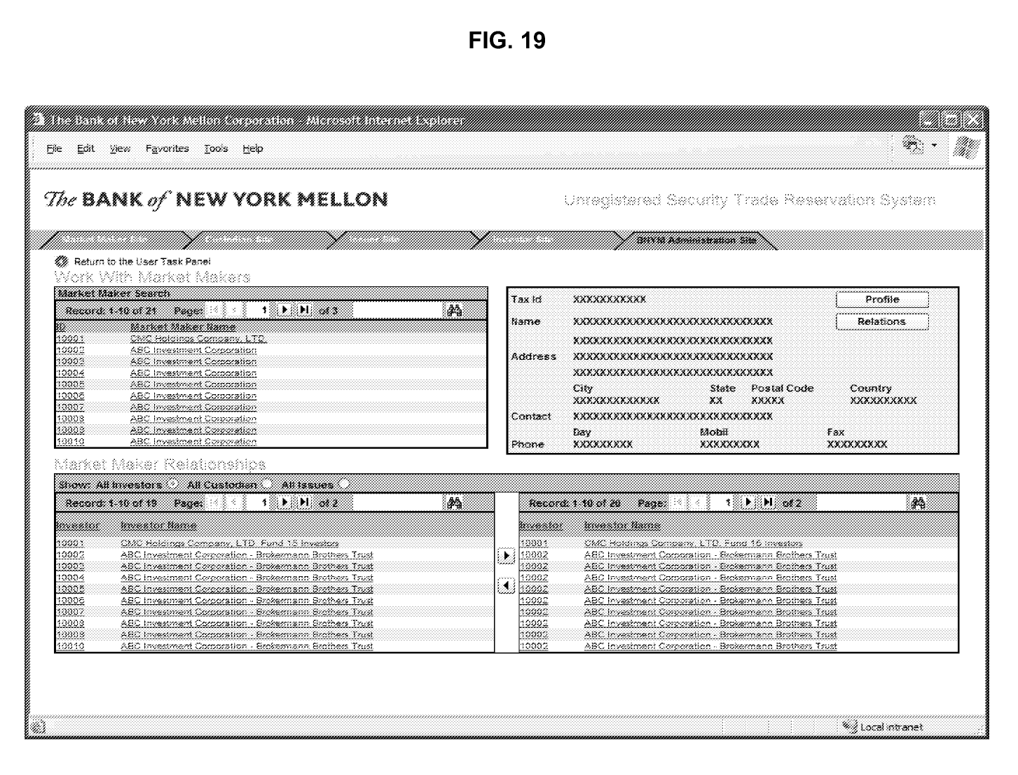

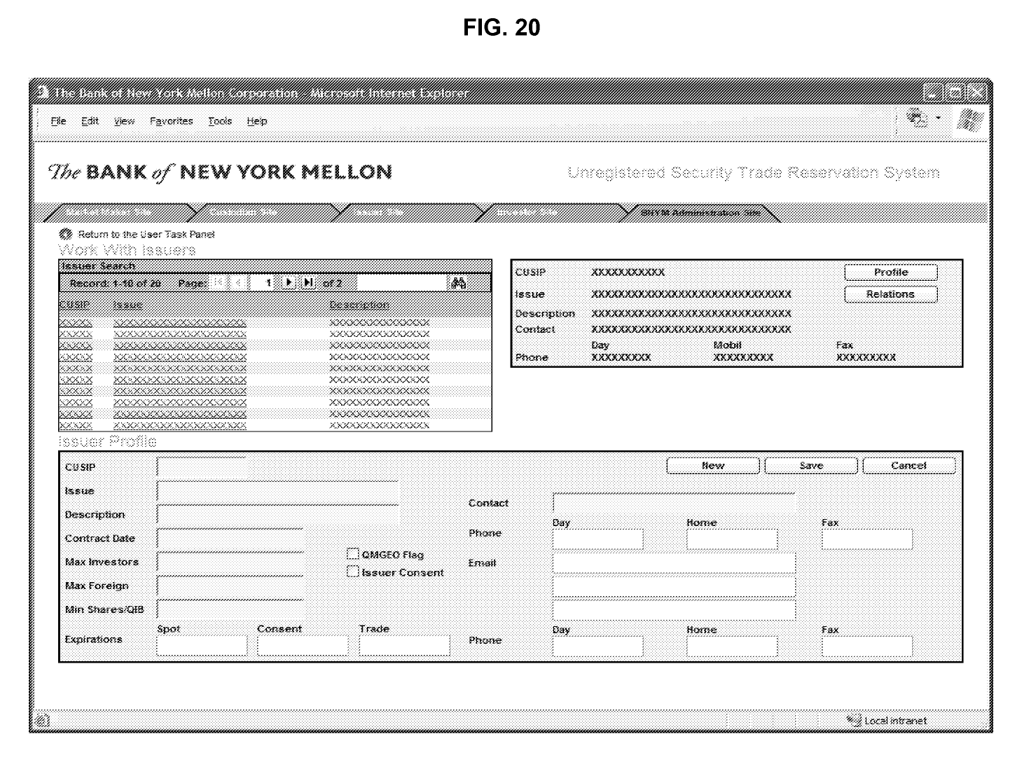

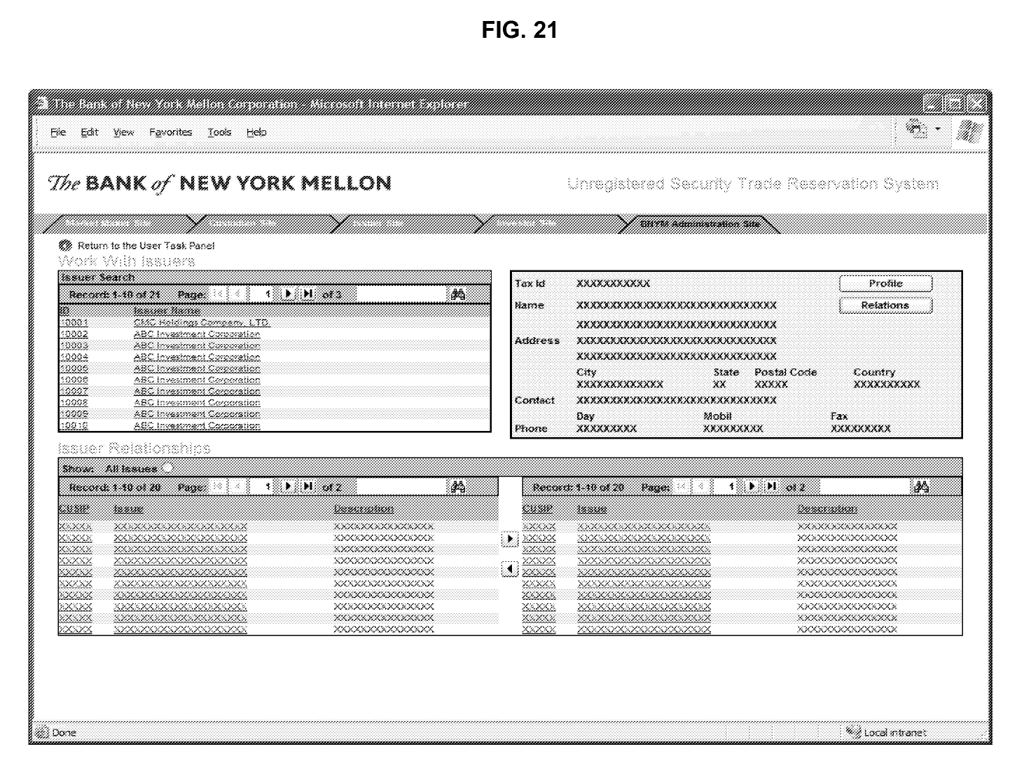

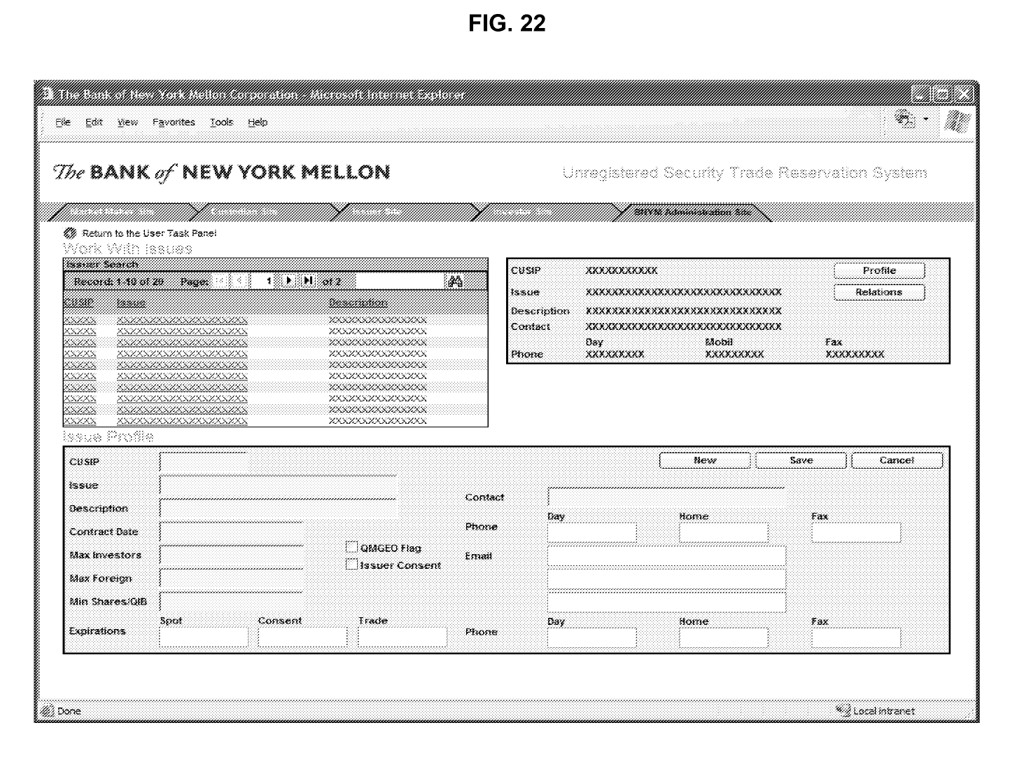

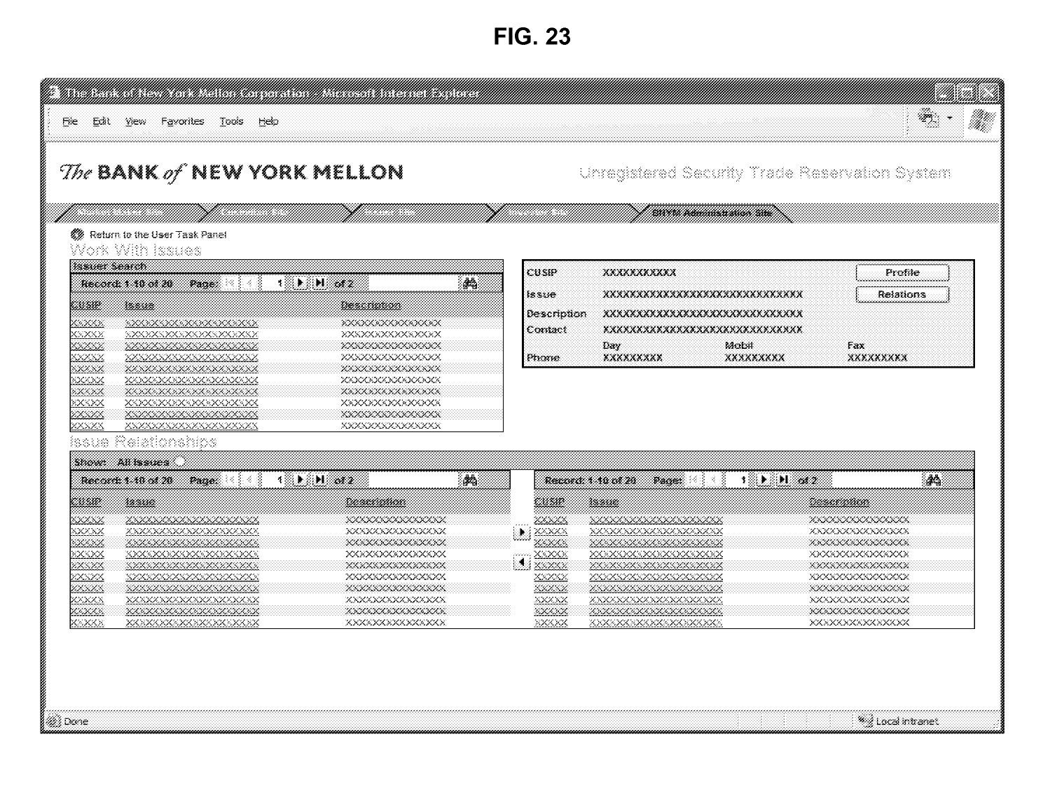

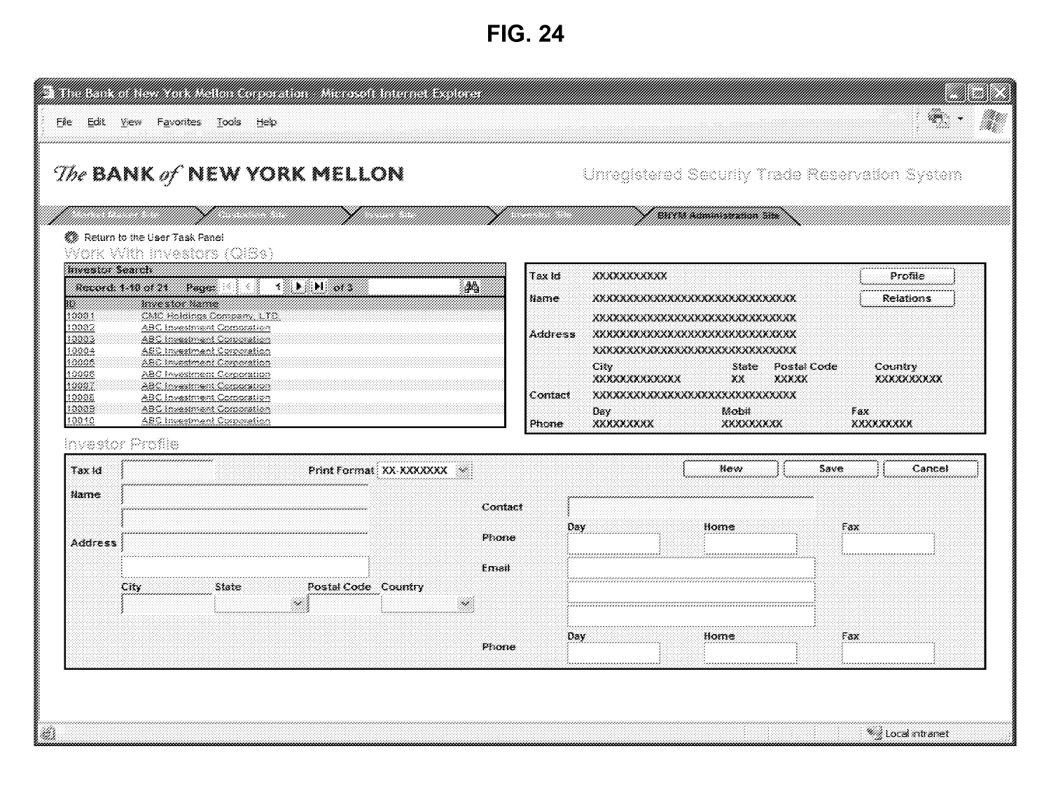

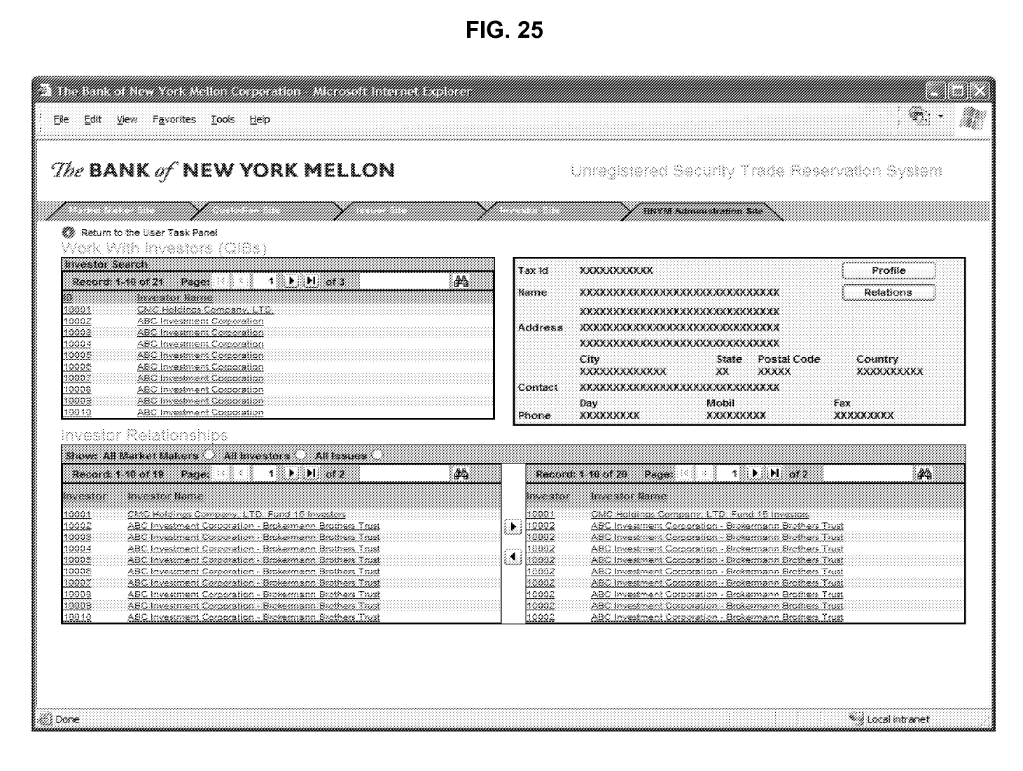

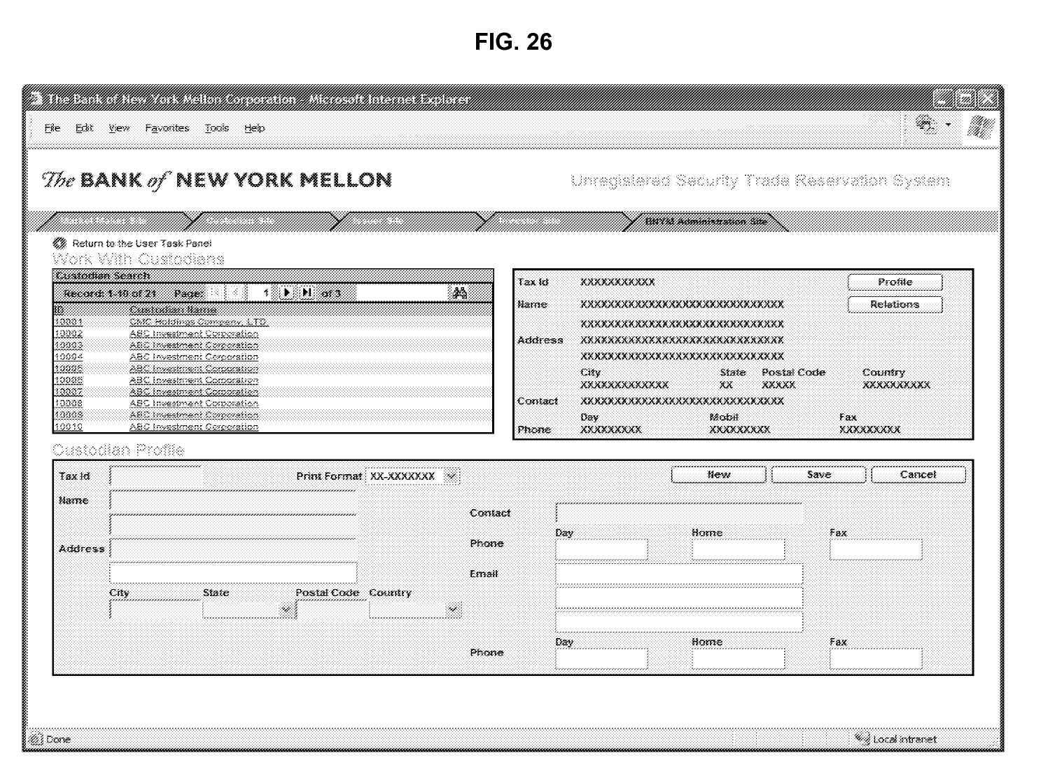

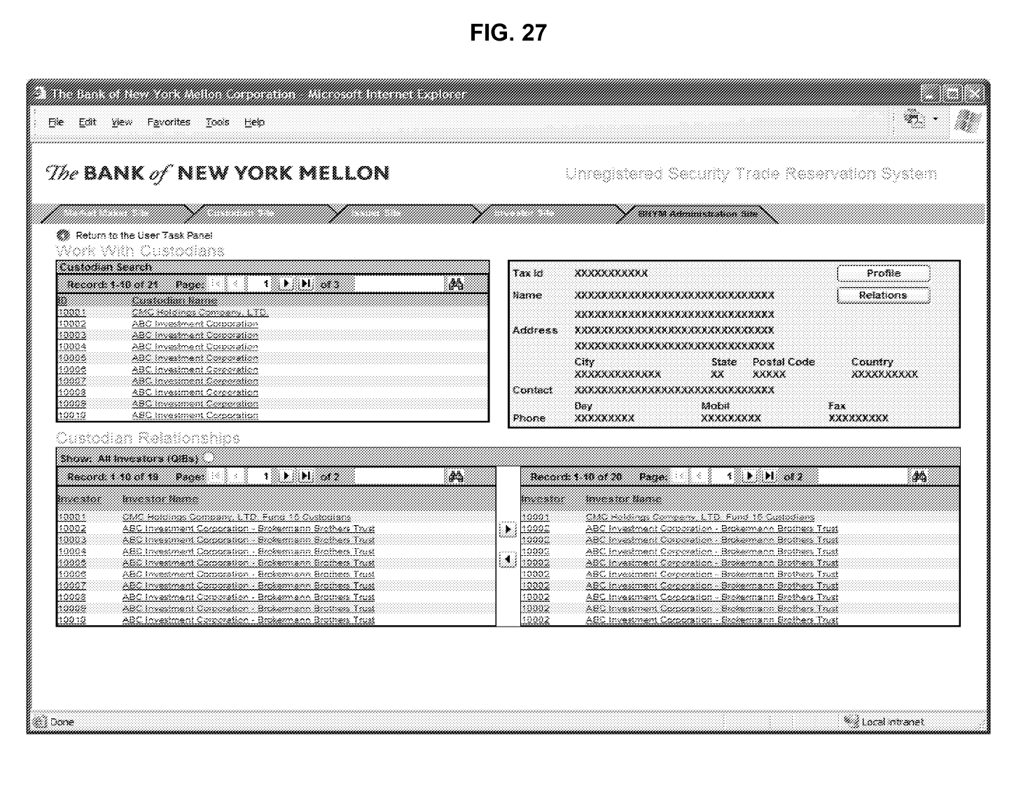

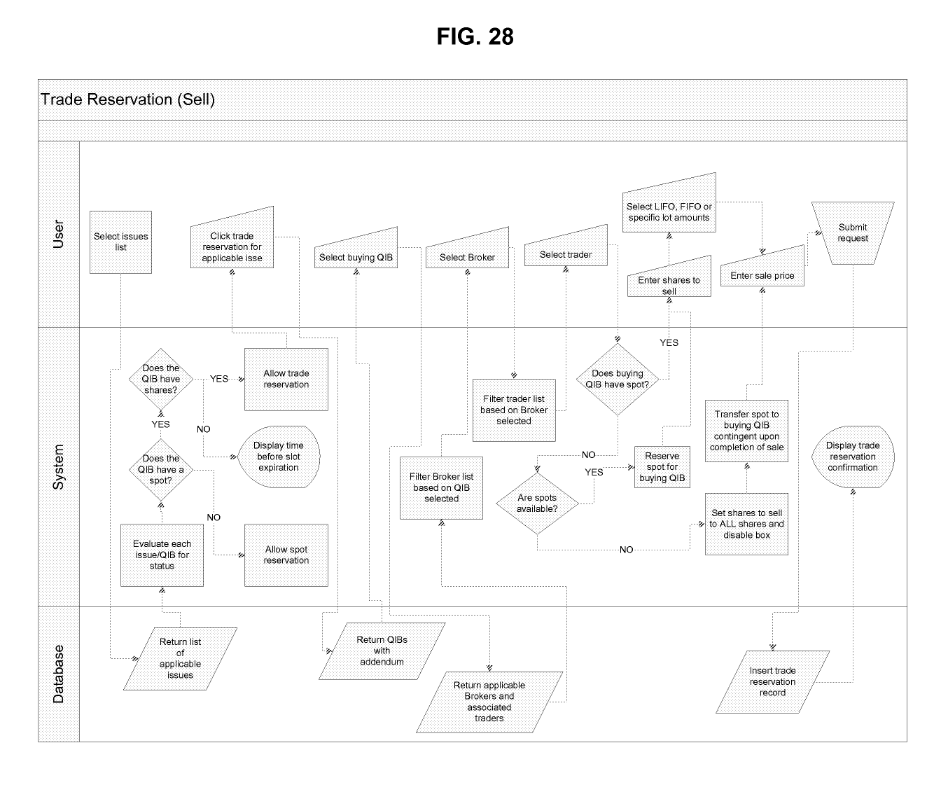

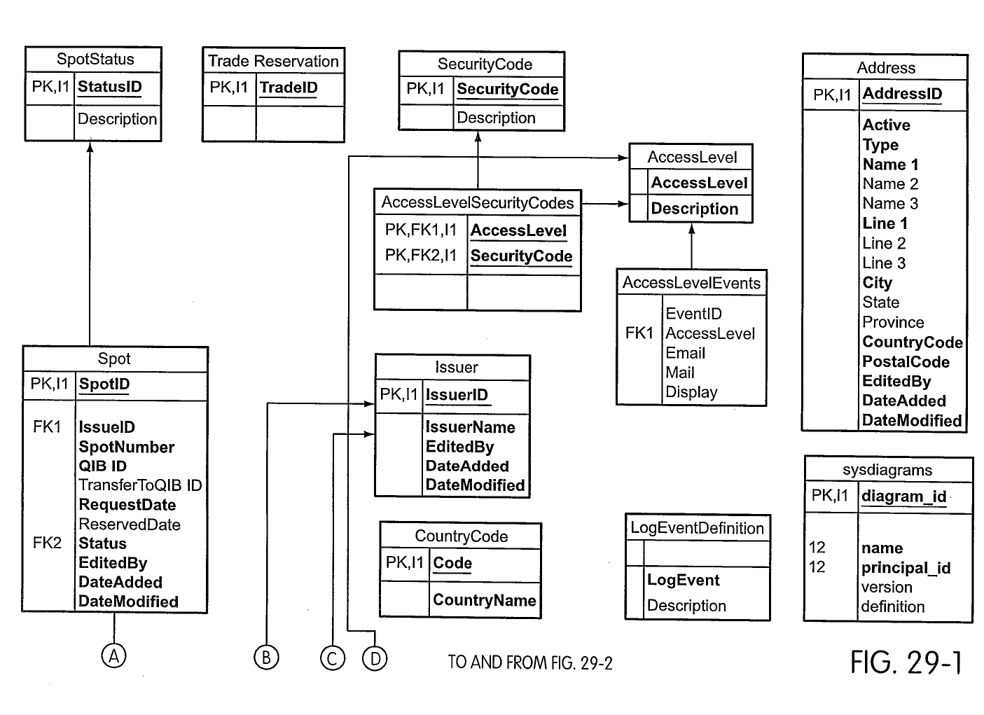

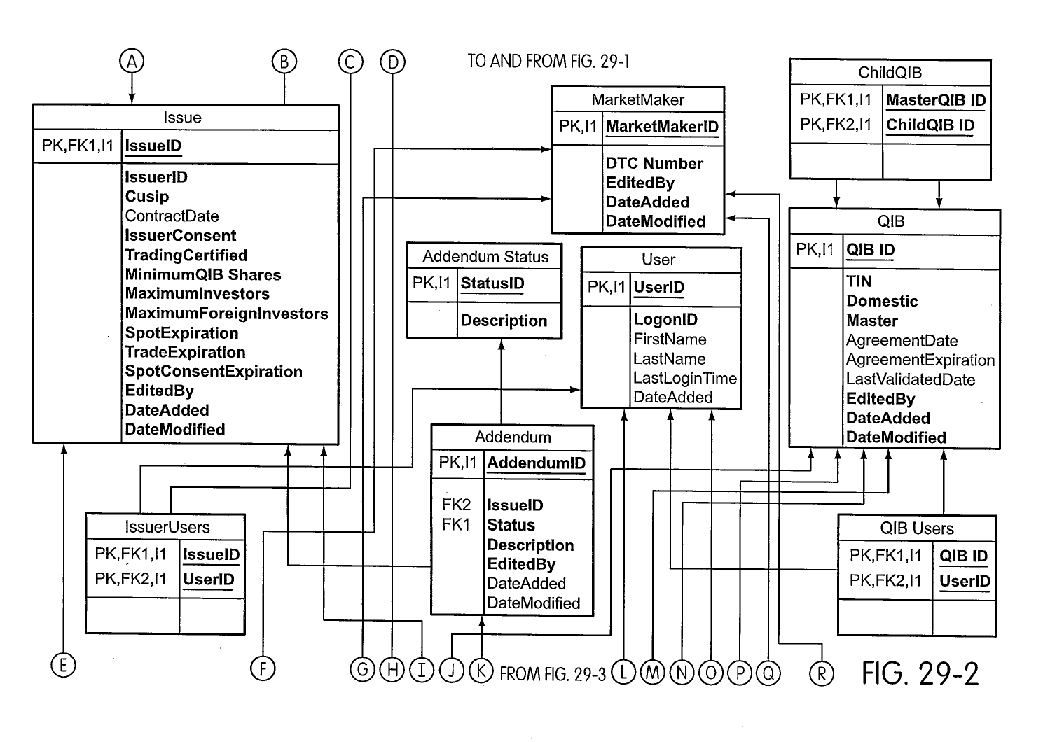

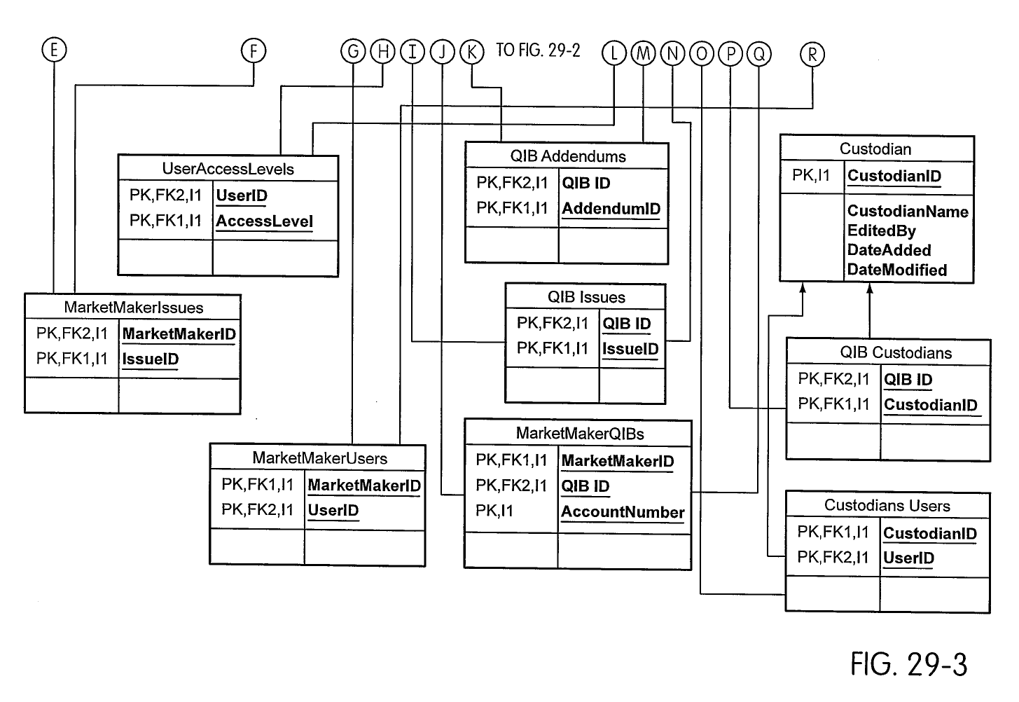

Various functional aspects of embodiments of the system and method of this disclosure will now be discussed. As would be known to a person of ordinary skill in the art, such functionality can be carried out by appropriately written computer software embodied on various types of computer-readable media, and executed on one or more computers. Program interfaces can be provided by a graphical user interface (GUI), such as provided by the Windows® operating system, for example, and as illustrated by FIGS. 4-27.

### Pre-Processing Before Initial Offering

The functions described below with respect to one or more exemplary embodiments of this disclosure may be thought of as pre-processing steps carried out prior to the initial offering of a Rule 144A Issue.

Issue-Related Functions

1. Establish a client: On the assumption that a client could have multiple Issues, the system should ensure that Issues can be associated with a client.

2. Establish an Issue: In addition to the functions relating to establishing a fund as performed by known Transfer Agent (TA) systems, the date that the Issuer signs a contract with the Platform Manager on behalf of the issue is stored in a database.

3. Establish compliance for an Issue: A Rule 144A Issue may have various regulatory and/or Issuer-mandated compliance issues.
a. The maximum number of investors and maximum number of non-domestic investors, which are stored as numeric variables;
b. Minimum number of shares that a QIB may hold, stored as a numeric variable;
c. A provision that the Issuer may approve a QIB prior to the QIB obtaining documents stored on the website, reserving a spot, and/or having a trade reservation entered.

4. Issuer users' access: At least two levels of Issuer “users” of the trade reservation system may exist:
a. Users who can obtain reports of shareholders, transactions, slot reservations, trade reservations; and
b. Users who can approve a QIB to access documents and make reservations.

5. E-mails to Issuers: Users may receive e-mails depending on events that occur, and should have the capability to receive e-mails concerning:
a. Slot reservation (includes potential expiration of a slot reservation);
b. Trade reservations made (and close to expiration);
c. Shares transferred (share trade settlement).

6. Issue CUSIP: The CUSIP number can be used as the key that identifies an Issue in the trade confirmation received by the platform manager and, as such, the CUSIP should be stored as a keyed field in the database, and check digit validation upon input of a CUSIP is generally prudent to ensure greater accuracy of the data input.

7. Trade-Execution Messaging System: Establish a flag in the Issue table that confirms that the Issuer has established the Issue in the Trade-Execution Messaging System, e.g., the Omgeo system, and that the platform manager/trade facilitator has been listed as an “Other Interested Party”. The flag may be used as a reminder to ensure that this step has been done since, without it, the platform manager/trade facilitator generally does not receive trade confirmations.

8. Expiration of a slot reservation: As described in the QIB Slot Reservation section below, QIB's must reserve a slot before a trade is placed for its purchase of shares. However, slot reservations expire within a default time period, for example, three days. Because the expiration of a slot is dependent upon each individual Rule 144A Issue, a slot reservation parameter in days is stored in the database for each Issue.

9. Expiration of a trade reservation: As described in the QIB Trade Reservation section below, QIB's must have a trade reservation before a trade is placed for its purchase of shares. Trade reservations may be caused to expire within a default amount of time, for example, one day. However, the expiration is parameter driven by each Issue; thus a trade reservation parameter in days may be stored in the database.

10. New Issue import function: An import capability is useful for loading a new Issue into the system that accommodates loading all QIBs and the initial purchases for each QIB into the database.

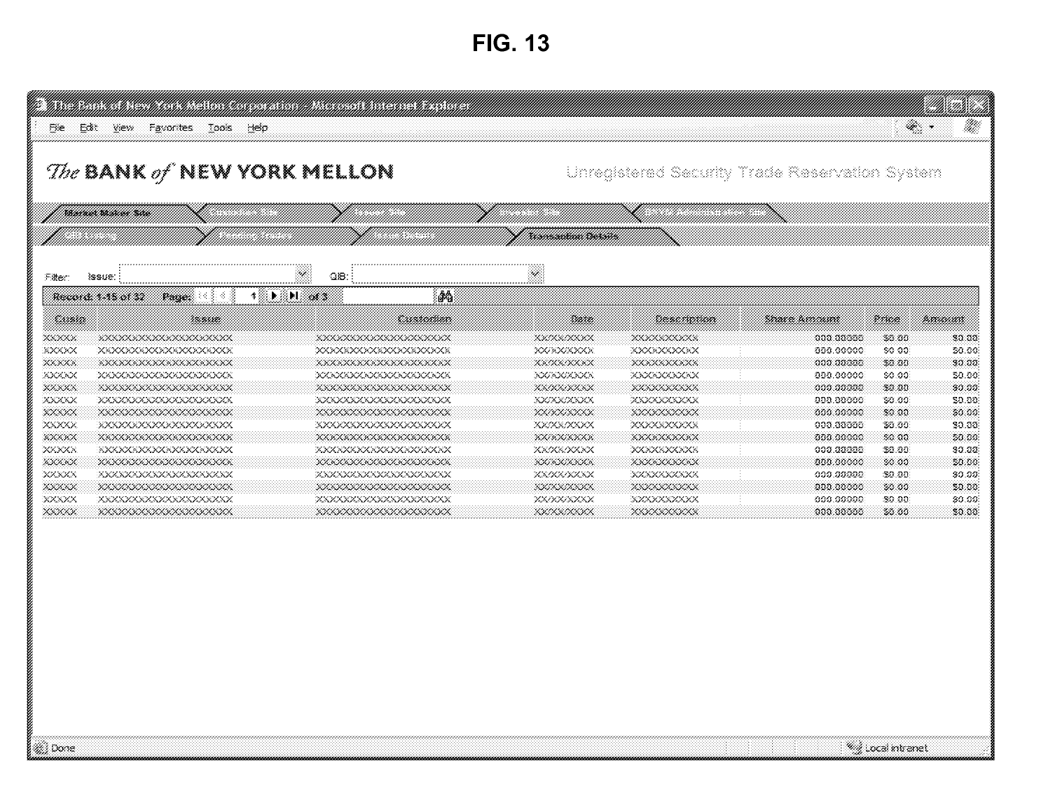

11. List of Market Makers: Various entities should be able to obtain a list of markets for a user-input Issue. The user would select the issue; the system would show the market makers for the issue as illustrated, for example, in the window of FIG. 13.

Functions Related to Broker Dealers/Market Makers

1. Establish a Broker Dealer (“B/D”): A broker/dealer may be established in the system as is done in known Transfer Agent systems.

2. Capture the B/D's DTC broker number: It is beneficial for the system to capture the B/D's DTC broker number before the B/D is entered into the system database.

3. Capture when a B/D is a market maker for a specific Issue: Each Rule 144A Issue will have one or more market makers who underwrite the initial offering of the Issue. The market makers may be granted permanent spots “at the table” whether they own shares or not, and each market maker is a QIB. This information is stored in the database for each issue.

4. B/D users' access: At least one level of B/D User access will exist.
a. Users will reserve a slot;
b. Users will enter a trade reservation;
c. Users will be able to confirm a trade reservation;
d. Users will be able to list all Issues;
e. Users will be able to list all transactions for all issues for all QIBs where their firm acted as a B/D; and
f. Issuers will be able to list all issues and all QIB positions where their firm acted as B/D. The position may be stored in the database as “current” or “as of” a particular date.

5. Broker Dealer Authorization: Consider all identified users for a Broker Dealer as authorized to act on behalf of all QIBs, for all issues, when a QIB has identified the B/D in a Master Agreement with the Platform Manager/Trade Facilitator.

Functions Related to Custodians

1. Establish a Custodian: Custodians may be established as in known Transfer Agent Systems.

2. Custodian users' access: One or more levels of Custodian User access may be allowed.
a. Users will generally be able to list all Issues;
b. Users will generally be able to list all transactions for all issues for all QIBs where their firm acts as Custodian. A transaction report may be down-loadable; and
c. A Custodian will be able to list all issues and all QIB positions where their firm acted as Custodian; the position may be stored in the database as “current”, or “as of” a particular date.

QIB Investor and Validation Functions

1. Determine Candidacy: To ensure compliance with SEC requirements, only recognized QIB's are permitted access. A record of QIB candidacy results is maintained by the system in the database.
a. In one aspect, a dual candidacy determination model can be applied wherein a prospective investor is a candidate to trade based on the rules of being a QIB, along with the additional constraint of not exceeding the investor limitation requirement, i.e., that an investment by a QIB would not cause the maximum investor limitation either set by SEC Regulations or by Issuer-imposed limitations to be breached. This information allow QIB's and Market Maker representatives to determine whether there is a “spot at the table” for a specific issue. A “spot” is an investor in the issue; having a “spot at the table” means that there are no more than the maximum number of investors specified for the issue.
b. A third level of candidacy, issuer consent, may be invoked selectively by the Issuer, i.e., issuer consent may selectively be turned on or off in the system. When an Issuer requires pre-approval of a candidate investor, the system may send the Issuer an e-mail notification. In one implementation, approval of the candidate investor will be presumed unless the Issuer objects within a issuer-defined time period.
c. In one implementation, the trade reservation system maintains a file of QIB investors in the database. Generally, a QIB investor must sign a Master Agreement with the Platform Manager/Trade Facilitator. As part of the candidacy process, the Platform Manager would require a written affirmation from the investor that they are a QIB, and make appropriate representations regarding Rule 144A. The date of the master agreement is the date that the QIB has attested its QIB status, and this date is maintained in the database. Additionally, the status of a QIB as a QIB should be re-validated periodically, and if a QIB is a foreign entity, the validation requirement has a different time period than if the QIB is domestic. The database is configured to store information concerning whether the QIB is foreign or domestic, and to also store the next date that re-validation is required.
d. In an alternative QIB validation implementation, the Platform Manager would engage the services of a third party compliance manager (e.g., Dealogic LLC) to validate that an investor interested in purchasing on the secondary market is a QIB. Validation of QIB status may be done through manual inquiry to a third party compliance manager, e.g., through a web page, or the trade reservation system can interrogate the third party compliance manager database automatically through an API, for example, whenever a QIB wishes to make a purchase trade reservation and the QIB's certification has expired. The date that QIB status was last validated is stored in the database, and each time a new validation is done, the “QIB status” date is updated as well as the “next validation due date”.
e. In addition to a QIB Master Agreement between the Platform Manager/Trade Facilitator, the QIB generally signs an Addendum to the Master Agreement for each issue in which it may wish to invest. The system must store data indicating the existence of the Addendum, and the date it was signed. In order from running afoul of SEC requirements, a QIB will generally be prohibited from reserving a spot and/or make a trade reservation without the Master Agreement and Issue-Specific Addendum being in place.
f. In some situations, the QIB Master Agreement and Issue-Specific Addendum will be signed by a QIB on behalf of itself and one or more QIB sub accounts. The QIB and all of the sub-account QIB's may be allowed to invest individually, and each can be set up as an individual “investor”. The system is configured to recognize this “master account-sub account” relationship for reporting and the establishment of QIB users, for example. As an example of a QIB master and QIB sub-account relationship, Fidelity Investments could sign for itself and on behalf of Fidelity Magellan Fund, Fidelity Large Cap Growth Fund, and others.

2. QIB identification: For each QIB, the following information may be provided and stored in the database for use in the trade reservation system.
a. The QIB Tax Identification Number. If the QIB is a foreign entity, a government established unique identifier for the QIB may be used;
b. Domestic or foreign entity information for each QIB;
c. For Issues that pay distributions, an indication of whether the distribution is to be taken in cash or reinvested;
d. For each broker/dealer with which it may trade, the QIB's account number at the broker/dealer;
e. Information concerning one or more custodian banks where the QIB may custody shares.

3. QIB Relationship to Other Entities: For a QIB signing an agreement on behalf of itself and its “child” QIBs, the authorized users will be able to act on behalf of all QIBs covered in the agreement; all Custodial relationships and all Broker Dealer relationships can be entered once, and cascaded down to the child QIBs. The relationship for users, custodians and dealers can be maintained at the child QIB level, thus enabling the relationships for the child QIBs to be different than the relationships of the parent QIB.

4. QIB Parent/Child Relationship Maintenance: The system has the ability to maintain (add, change, delete) relationships between Parent and Child QIBs.

5. Recordation of Master Agreement Terminations: The system provides the ability to record when a Master Agreement is terminated, thus causing a “freeze” to be put on the QIBs account for future transactions.

QIB Slot Reservation

1. QIB Trade Slot Reservation: An interested QIB may request a trade slot by logging into a trade platform portal and requesting a slot for a specific issue. Various levels of access control may be provided in the slot reservation process.
a. The potential investor would first be pre qualified by the system as a QIB. Upon validation, they would be provided with an investor identifier that would permit access to quotes from a market maker;
b. If the potential investor wish to open a trade slot, the slot would be requested electronically;
c. Assuming no objection, the slot would be held open for a variable period of time [n] as determined by the Issuer, or as a default value of 3 days, and as stored in the database. This slot would be considered an account for purposes of monitoring the investor limitation requirement;
d. The slot could automatically lapse [n] days after being granted or upon an account being opened in the “reserved slot”.
e. A slot reservation is not required; a trade reservation being entered will result in a slot reservation being entered if the buying QIB has not already reserved a slot for the issue being traded.

2. Market Maker Trade Slot Reservation: Market Makers specified by the Issuer may be provided permanent slots and, in such a situation, they should be counted as a slot holder irrespective of their ownership of shares.

3. Slot Request Response: The Platform Manager will generally send the results of the reservation request back to the QIB by email, for example, and could include expiration time, slot identifier, and other information pertinent to the reservation request. In another aspect, the trade system could be configured to inform the participant of the results via a message on a website welcome page the next time the QIB logs into the system.

4. Slot Availability Reporting: In another aspect, the Platform Manager can provide a report of slot status that may be accessed via the website upon user request and/or the report may be downloaded as a file. The report could be configured to include every new slot request received by the Platform Manager, and could identify the status of each slot request as either “accepted”, “rejected”, or “pending”. Reports on accepted applications may include a slot number.

5. E-mail notification of a spot reservation: E-mails may be sent to the trader and the QIB under the following exemplary circumstances:
a. A spot reservation is granted;
b. One day before a spot reservation will expire unless the expiration period set by the Issuer is one day.

### Initial Offering

The steps and functions identified below are generally carried out after the pre-processing above, and are more generally related to an actual offering and trade of a Rule 144A Issue.

QIB Trade Reservation

1. Set up a trade reservation: All prospective trades, including purchases by an existing Issuer QIB investor, may be established by a selling QIB's trader in the Trade Reservation system. Before a QIB that does not own shares can establish a trade reservation, it must reserve a slot as specified above.

2. Confirm a trade reservation: In one aspect, a trade reservation set up by a trader for a selling QIB must be confirmed by the trader for the purchasing QIB. Once the trade reservation is confirmed by the purchasing QIB, it is established as a trade reservation.

3. Reservation expiration: A trade reservation expires after [n] days as established by the Issuer, or a default expiration period can be used, e.g., two (2) days.

4. E-mail notification of a trade reservation: The system may send E-mails to the traders and the QIB when the following occurs:
a. A trade reservation is set up;
b. A trade reservation is confirmed; or
c. One day before a trade reservation will expire, unless the expiration period set by the Issuer is one day.

### Trade Execution

The steps and functions identified below are generally carried out in connection with the actual execution of a trade.

Trading & Settlement

1. Trade notification: In one embodiment, and in response to a trade executed in a broker-dealer system, the trade information messaging system (e.g., the OMGEO system) may automatically generate messages to the Platform Manager/Trade Facilitator.
a. One trade confirmation may be sent for the sell side, and another for the buy side. The confirmations will be received independently of each other.
b. The trade reservation system will match the confirmatory messages to a trade reservation based on one or more of the DTC broker number, the broker's internal account number for the QIB, the share amount, and the per-share price, for example.
c. In another aspect of this embodiment, Trade Platform Manager operators may validate a transaction through a web interface, i.e., through a website, once purchase and sale confirmations are received through the trade information messaging system.
d. While the primary transaction currency will be United States dollars, the system can be configured to deal in various other legally traded currencies.
e. The system may provide that all transactions shares are immediately available, so that shares pending purchase for a QIB should be immediately available for sale. However, in all cases, transactions should not affect the Issue register until settlement has been verified. The actual trade need not be performed through the system of this disclosure. Once confirmed, the trade may actually settle days later. To ensure validity of the trade process, the system can provide for reconciliation and proof at each step of the process through various reports.

2. Funds movement: Funds movement generally will occur outside of the Trade Reservation System of this disclosure.

3. Share Movement: In one embodiment, the system may provide for electronic matching of trades as communicated on the confirmatory messages with trade reservations.
a. Once matched, shares may be moved electronically from seller to buyer on the Transfer Agent register on the date using the trade date in the confirmatory messages.
b. If trade confirmations cannot be electronically matched with trade reservations, the trade platform may initiate standard, manual exception handling processes to attempt to find the trade reservation in hopes of being able to settle the trade.
c. In the event that trade confirmations cannot be matched, the system may generate advisory messages through the trade information messaging system to traders and the particular QIB for any trades that cannot be settled.
d. Completed share movement may generate e-mails to the settlement departments of the selling and buying traders and to the selling and buying QIB's.

4. Transaction Details: In one embodiment in which trades are executed through a website, the system is configured to allow Issuers, Custodians, QIB's and Market Makers the ability to view transaction details and account summary information for issuers and QIB's for which they are authorized to view and/or conduct transactions.

5. Statements: In one aspect, position statements will be issued by the Platform Manager/Trade Facilitator to custodians and QIB's on a periodic basis, e.g., on a monthly basis.
a. After the authorized selling trader enters a trade reservation for a QIB, an e-mail notification of the proposed trade reservation may be sent to the selling and buying traders and QIB's.
b. The traders for the purchasing QIB may be provided the ability to approve a trade reservation entered by the selling trader.
c. An e-mail confirmation of the approval/disapprove may be generated to the buying and selling trader and QIB.
d. Email notifications may be sent to all interested parties updating a transaction's status when appropriate or desired.

Disbursements

1. Cash Distributions: Issuer cash distributions may be handled by the Platform Manager using known cash distribution protocols. Cash may be distributed via check or an Automated Clearing House (ACH) transaction to the custodian for benefit of (FBO) the QIB as recorded at the time of purchase.

2. Share Distributions: Share distributions may be handled by the Platform Manager using known share distribution protocols.

3. Reinvestment: In one aspect, and in lieu of a distribution payment in cash, distributions may be reinvested at the direction of the QIB if reinvestment is offered and authorized by the Issuer.

4. Dividend Distribution: In one embodiment, the system may provide a process to distribute dividends to a QIB based on dividend rules of the Issue.

### Miscellaneous Features

Investor Communication

1. QIB Solicitation: The system may be configured to make a known proxy process available for use, as needed by the Issuer.

2. Issuer Communications: The system may be configured to house both generic issuer communications (i.e. a news release or financial statement) as well as QIB-specific communications (i.e. cost basis and tax data).

3. Automatic Notification: In one or more embodiments, QIB's may be notified of the availability of new communications pieces by automated e-mail and/or when logging into the trade reservation system.

System Capabilities

1. Single Sign On: The system may support a so-called single sign on to allow a QIB to access a broker account held with the Platform Manager or on a system with other entities affiliated with the system without the need to sign in again into the other entities system.

2. Application Receipt Acknowledgement: The systems may provide an acknowledgement to the Issuer for every account requested and/or opened.

3. Web Access Password Security: The system may be configured to implement various security features, e.g., password complexity and expiration requirements.

4. Position File Download Capability: In one or more embodiments, the system may be configured to provide the capability for Custodians to download position files for all QIBs of the Custodian, and to generate position files for Custodians.

5. NET Web Services Interface: In one or more embodiments, the system may provide an API to allow Market Makers to develop interfaces to NET web services, thus allowing integration with existing trading interfaces at the Market Maker.

6. Set Up and Maintenance Features: One or more embodiments of the system may be configured to provide the following features:
a. A process for loading QIB's and authorized QIB users.
b. A process to enter Issues, issuers' users, and issue parameters, such as a maximum number of investors.
c. A process to enter Custodians and custodian users. If a contract is signed with a custodian that permits use of the system, the contract terms and expiration may also be stored.
d. A process to enter Broker/Dealers and B/D users: The process enables a B/D to be specified as a Market Maker for specific issues. If a contract is signed with a B/D, the contract terms and expiration may also be stored in the database.

Reporting Capabilities (with Various Access Control Levels)

1. Slot Status: The system may be configured in one or more embodiments to report the total number of QIB accounts and Slot Requests, along with the slot history.

2. System Tracking Issues, Issuers, QIB's, Traders, Market Makers: In one or more embodiments, Tracking Features may include:
a. Track all issues and the associated compliance for each issue (i.e. minimum investment amount, maximum investors, approval of QIBs required, days to hold slot reservations, days to hold trade reservations, etc.
b. Track all Issuer's users that are allowed to approve QIB's for a specific Issue (user's to be supplied on Issuer/TA contract).
c. Track all QIB's, the date they sign a master agreement with the Transfer Agent, and the expiration date of the agreement. Agreement to supply list of authorized Market Makers who can enter trade reservations on behalf of the QIB, authorized Traders who can approve trade reservations, and the QIB account number at each Market Maker.
d. Track all Traders that are allowed to act on behalf of a QIB (approve sale and purchase orders).
e. Track all Market Makers and record the details of the contract they sign with the Platform Manager.
f. Track all QIB account numbers at a specific Market Maker (used to identify trades received through the trade messaging system).
g. Track all transactions (buy/sell) for a QIB within a specific issue, including an indication of whether the shares are kept in book or physical form, as well as the custodian for each purchase.

3. Account Relationships: Account positions and relationship by bank/broker, and QIB positions cross CUSIP.

4. Account Activity: The system may be configured to store activity on one or more of an Account activity basis, cost basis, or history.

5. Closed Accounts: Total accounts open and closed over time.

6. Disbursement history: Amount and instructions.

7. Tax Reporting: In one or more aspects, the system may provide various tax reporting on dividends. Sales may be executed and reported by various broker/dealers with no or limited involvement by the Platform Manager.

8. Financial Statements: In one or more embodiments, the system allows documents such as financial statements to be posted and retrieved by authorized users via a website. Access can be provided to documents depending on a particular user or class of user.

9. Proof and Reconciliation: The system may be configured to provide exemplary accounting functionality such as transactions in/out, pending transactions matched/unmatched, available slots, slot/trade reservations auto-cancelled transactions, and daily reports. In addition, an audit trail may be provided for transactions as they proceed through the system.

System Design Parameters

1. Scalability for Additional Brokers: In one or more embodiments, the system design is scalable to support arrangements with multiple brokers, in which each broker may have its own candidacy rules, disbursement methods, new account setup process, etc.

2. Scalability for Additional Types of Transactions: Although one purpose of this disclosure is to provide a trade reservation platform for private equities issued under Rule 144A, the method and system of this disclosure may be configured to accommodate different types of domestic and non-U.S. investments such as debt issues, short sales, collateral management, derivatives, foreign exchange, and foreign equities traded, for example, on the Alternative Investment Market (AIM) (a sub-market of the London Stock Exchange) that has a more flexible regulatory system than is applicable to London's Main Market.

3. Scalability for QIB-Broker Relationship: One or more aspects of various embodiments of this disclosure allow for one QIB to relate to one or more brokers and/or custodians. Via the system, a QIB may also designate disbursements to go to an alternate location.

4. Scalability for Pledging: In various aspects, the system design allows for a QIB to pledge holdings and the Platform Manager to provide a Secure Control Location (“SCL”).

### DISCUSSION OF VARIOUS EMBODIMENTS

In one embodiment, a computer-implemented, web-interfaced method of trading and settlement of unregistered securities issued under an exception outlined in Rule 144A of the Securities Act includes providing a website hosted by a networked computer. A data structure is established in a memory accessible by a computer (either a different computer or the same computer that hosts the website) in which the data structure includes information relating to one or more unregistered securities and entities involved with the trading and settlement of the securities being traded.

A trade request is received via the computer network from one or more interested investors pertaining to a particular unregistered security being offered for sale. A determination is made by a compliance manager concerning whether the interested investors are considered qualified as a QIB under Rule 144A. Eligibility as a QIB may be determined for each of the interested investors by an “internal” compliance manager, i.e., an entity under the direct, internal control of the trade platform manager, or by a third party such as Dealogic, LLC. From this eligibility status, the eligibility of interested investors to proceed with a trade as a QIB may be established.

For each of the one or more QIBs, an investment slot is allocated if a number of investment slots is less than a regulated value (e.g., 500 investors for U.S. securities, and 300 U.S. investors if non-U.S. securities are involved). Otherwise, an investment slot is declined to any investors that are not qualified as a QIB.

In a further aspect of this embodiment, the unregistered securities are traded in a primary market. Information relating to the various entities includes one or more of issuers, underwriters, one or more QIBs, and one or more custodians of the unregistered securities.

In a different aspect of this embodiment, the unregistered securities are traded in a secondary market. Information relating to the various entities includes one or more broker/dealers of the unregistered securities, one or more QIBs, and one or more custodians of the unregistered securities.

In various aspects of this embodiment, an investment limit established by an issuer for each allocated investment slot may be enforced, and a sale of specific shares of a particular security to each QIB may be accounted for by a book-entry record keeping system. Notifications of each sale of unregistered securities to selected entities involved with the trading and settlement may be made. Such notifications may be made by utilizing services of a transfer agent, or by sending an e-mail to selected entities involved with the trading and settlement.

In further aspects of this embodiment, custody of one or more purchased shares may be managed on behalf of a purchasing QIBs and may either be carried out by an entity having operational control over the website, e.g., the Platform Manager, or by monitoring custody of the purchased shares by a third party.

In various aspects of this embodiment, the regulated value of investors is either 500 U.S. investors for U.S. securities, or 300 investors when the securities are non-U.S. issues, as required under Rule 144A of the Securities Act.

In this and other embodiments, the data structure may be implemented by a structured database having an internal structure determined, at least in part, by a number of specific portions that are separately extracted from a variety of information sources. For example, the structured database may include a shareholder registry. Optionally, information relating to a market maker, a custodian, an issuer, any pending trades, any completed trades, and a share balance for each QIB may be stored in the data-structured memory for each unregistered security.

The data-structured memory may store a variety of desired information. For example, for each QIB, information relating to unregistered securities in which each QIB has a position, a market maker, a custodian, an issuer, any pending trades, any completed trades, and a share balance. In addition, various combinations of information may be stored in the structured database relating to one or more of: a purchase date, a number of shares purchased thereon, a custodian thereof, and a desired number of shares to be sold may be stored in the data-structured memory for each QIB and for a particular issue of an unregistered security. Further, information relating to a selling QIB and a buying QIB, any pending trades for a particular QIB, a last trade date, a last trade price, a number of QIB investment slots already filled, a number of QIB investment slots available for investment, a last trade date, a last trade price, a number of foreign QIB investment slots already filled, and a number of foreign QIBs investment slots available for investment, transaction details for sales of each unregistered security including information relating to a custodian, a trade date, a share amount, and a share price, reporting information relating to any sales of each unregistered security, said reporting information including, for each sale, an issue name, identifying information for a selling QIB, identifying information for a purchasing QIB, a number of shares traded, and a price per share.

In other aspects of this embodiment, a selected portion of the reporting information may be exported to a spreadsheet program, and/or a custodian report for a selected purchasing QIB may be generated. The custodian report may include a position report for one or more QIBs.

In various aspects of this and other embodiments, the website may be accessed through a participating broker/dealer selected from a plurality of participating broker/dealers.

In another embodiment, a computer-implemented trade reservation system facilitates trade and settlement of one or more unregistered securities issued under an exception outlined in Rule 144A of the Securities Act includes one or more networked computers. One or more memories are operably connected to a computer. The memory may be configured to store a data structure that includes information relating to said one or more unregistered securities and to entities involved with the trading and settlement of the securities. One or more broker/dealer interfaces are configured to connect with a computer via the computer network and to, on behalf of one or more interested investors, receive and process potential trades pertaining to one or more selected unregistered securities. Actual trades and cash settlement are conducted outside the system in one or more embodiments.

An interface is provided with a compliance manager that communicates data, with the computer network, and the compliance manager interface is configured to receive, as determined by the compliance manager, either (a) a verification of QIB status under Rule 144A, or (2) an indication of ineligibility as a QIB for particular investors.

A processor in the computer is configured to allocate an investment slot to one or more eligible QIBs if a number of allocated investment slots is less than a regulated value. Otherwise, the system declines to allocate an investment slot to investors that are ineligible as a QIB.

In various aspects of this embodiment, a website may be implemented on a computer or on a server separate from the computer. Further, the broker/dealer interfaces may implemented via a web interface.

In various aspects of this and various embodiments, the data structure stored in the memory may include a variety of combinations of information including: information relating to one or more of issuers of the unregistered securities, underwriters of the unregistered securities, one or more QIBs, one or more custodians of the unregistered securities, one or more broker/dealers of the unregistered securities, one or more QIBs, one or more custodians of the unregistered securities, a shareholder registry, for each unregistered security, information relating to a market maker, a custodian, an issuer, any pending trades, any completed trades, and a share balance for each QIB, for each QIB, information relating to unregistered securities in which said each QIB has a position, a market maker, a custodian, an issuer, any pending trades, any completed trades, and a share balance, for each QIB and for a particular issue of an unregistered security, information relating to a purchase date, a number of shares purchased thereon, a custodian thereof, and a desired number of shares to be sold, for each unregistered security, information relating to a selling QIB and a buying QIB, for each unregistered security, information relating to any pending trades for a particular QIB, for each unregistered security, information relating to a last trade date, a last trade price, a number of QIB investment slots already filled, and a number of QIB investment slots available for investment, for each unregistered security, information relating to a last trade date, a last trade price, a number of foreign QIB investment slots already filled, and a number of foreign QIBs investment slots available for investment, transaction details for sales of each unregistered security including information relating to a custodian, a trade date, a share amount, and a share price, reporting information relating to any sales of each unregistered security including, for each sale, an issue name, identifying information for a selling QIB, identifying information for a purchasing QIB, a number of shares traded, and a price per share.

In other aspects of this embodiment, an enforcement manager may be configured to enforce an investment limit established by an issuer for each allocated investment slot. In a further aspect, the processor may be configured to account for a sale of specific shares of a particular security to each QIB via a book-entry record. In other aspects of this embodiment, a notification manager may be configured to provide notifications of each sale of unregistered securities to selected entities involved with the trading and settlement. An interface with a transfer agent may be configured to provide required notifications of each associated sale to the transfer agent.

In other aspects of this embodiment, an e-mail agent may be provided in data communication with the computer network and the computer to provide required notifications of each sale via one or more e-mails sent to selected entities involved with the trading and settlement.

In other aspects of this embodiment, a custody manager in data communication with the computer network may be configured to either manage custody of purchased shares on behalf of one or more purchasing QIBs, or by monitoring custody of shares by a third party.

In various aspects of this embodiment, a report manager may be configured to create a report incorporating reporting information relating to a trade of an unregistered security, and the report manager may be configured to interface with a spreadsheet program so as to export selected portions of the reporting information into a spreadsheet. In addition, the report manager may be configured to generate a custodian report for a selected purchasing QIB, and the custodian report may include a position report for one or more QIBs.

In various aspects of this embodiment, the system may be accessed through a website by a participating broker/dealer or through a plurality of participating broker/dealers.

In another embodiment, a computer program product for use with a computer in connection with facilitating trading and settlement of unregistered securities issued under an exception outlined in Rule 144A of the Securities Act contains computer-readable instructions thereon which, when executed on the computer, cause the computer to carry out various functions. These functions include interfacing with a computer network; establishing a data structure stored in a memory that includes information relating to one or more unregistered securities and entities involved with the trading and settlement thereof; processing trades made by one or more interested investors pertaining to one or more of the unregistered securities; receiving a Rule 144A Qualified Institutional Buyer (QIB) eligibility status from a compliance manager for each of the one or more interested investors; determining one or more QIBs from the QIB eligibility status for each of the one or more interested investors; allocating an investment slot to said one or more QIBs if a number of allocated investment slots is less than a regulated value, and making a transfer reservation before a broker initiates a trade.

It should be noted that this disclosure is directed to a slot and transfer reservation system and method in which a slot reservation and a trade reservation occur before a broker initiates a trade. Further, cash settlement of trades facilitated by the system and method of this disclosure are handled by the buyer and seller outside of the system, while share movement is handled within the system of this disclosure.

The foregoing describes only various aspects of embodiments of the disclosure, and modifications, obvious to those skilled in the art, can be made thereto without departing from the scope of the disclosed and claimed invention.

What is claimed is:

1. A computer-implemented, web-interfaced method of reserving a trade slot and transferring unregistered securities issued under an exception outlined in Rule 144A of the Securities Act, the method comprising:
providing access to a website in communication with a network;
establishing a data structure stored in a memory accessible by a processor, said data structure including information relating to one or more unregistered securities and entities involved with the trading and settlement thereof,
receiving, via the network, a trade inquiry from one or more interested investors pertaining to a particular one of the one or more unregistered securities;
receiving, via the network, a Rule 144A Qualified Institutional Buyer (QIB) eligibility status information from a compliance manager for each of the one or more interested investors;
determining one or more eligible QIBs using the received QIB eligibility status information;
for each of the one or more eligible QIBs, allocating an investment slot if a number of allocated investment slots is less than a regulated value and otherwise declining an investment slot to remaining ones of the eligible QIBs; and
for each allocated investment slot, making an associated security transfer reservation before a trade is initiated.

2. The method of claim 1, wherein said unregistered securities are traded in a primary market and said information relating to said entities comprises one or more of issuers of the unregistered securities, underwriters of the unregistered securities, one or more QIBs, and one or more custodians of the unregistered securities.

3. The method of claim 1, wherein said unregistered securities are traded in a secondary market and said information relating to said entities comprises one or more broker/dealers of the unregistered securities, one or more QIBs, and one or more custodians of the unregistered securities.

4. The method of claim 1, further comprising enforcing an investment limit established by an issuer for each allocated investment slot.

5. The method of claim 1, further comprising accounting for a sale of specific shares of a particular security to each eligible QIB via a book-entry record keeping system.

6. The method of claim 1, further comprising providing notifications of each sale of unregistered securities to selected ones of the entities involved with the trading and settlement.

7. The method of claim 6, wherein said providing required notifications of each associated sale comprises utilizing services of a transfer agent.

8. The method of claim 6, wherein said providing required notifications of each associated sale comprises sending an e-mail to selected ones of the entities involved with the trading and settlement.

9. The method of claim 1, further comprising managing custody of one or more purchased shares on behalf of one or more purchasing QIBs.

10. The method of claim 9, wherein said managing custody of one or more purchased shares is carried out by an entity having operational control over the web site.

11. The method of claim 9, wherein said managing custody of one or more purchased shares is carried out by monitoring custody of the one or more purchased shares by a third party.

12. The method of claim 1, wherein the unregistered securities comprise U.S. securities, and the regulated value is 500 investors under said Rule 144A of the Securities Act.

13. The method of claim 1, wherein the unregistered securities comprise non-U.S. securities, and the regulated value is 300 investors under said Rule 144A of the Securities Act.

14. The method of claim 1, wherein the structured database comprises a shareholder registry.

15. The method of claim 1, further comprising storing in the data-structured memory for each unregistered security, information relating to a market maker, a custodian, an issuer, any pending trades, any completed trades, and a share balance for each of one or more purchasing QIBs.

16. The method of claim 1, further comprising storing, in the data-structured memory for each purchasing QIB, information relating to unregistered securities in which said each purchasing QIB has a position, a market maker, a custodian, an issuer, any pending trades, any completed trades, and a share balance.

17. The method of claim 1, further comprising storing, in the data-structured memory for each purchasing QIB and for a particular issue of an unregistered security, information relating to a purchase date, a number of shares purchased thereon, a custodian thereof, and a desired number of shares to be sold.

18. The method of claim 1, further comprising storing, in the data-structured memory for each unregistered security, information relating to a selling QIB and a buying QIB.

19. The method of claim 1, further comprising storing, in the data-structured memory for each unregistered security, information relating to any pending trades for a particular QIB.

20. The method of claim 1, further comprising storing, in the data-structured memory for each unregistered security, information relating to a last trade date, a last trade price, a number of QIB investment slots already filled, and a number of QIB investment slots available for investment.

21. The method of claim 1, further comprising storing, in the data-structured memory for each unregistered security, information relating to a last trade date, a last trade price, a number of foreign QIB investment slots already filled, and a number of foreign QIBs investment slots available for investment.

22. The method of claim 1, further comprising storing, in the data-structured memory, transaction details for sales of each unregistered security including information relating to a custodian, a trade date, a share amount, and a share price.

23. The method of claim 1, further comprising storing, in the data-structured memory, reporting information relating to any sales of each unregistered security, said reporting information including, for each sale, an issue name, identifying information for a selling QIB, identifying information for a purchasing QIB, a number of shares traded, and a price per share.

24. The method of claim 23, further comprising exporting a selected portion of the reporting information to a spreadsheet program.

25. The method of claim 1, further comprising generating a custodian report for a selected purchasing QIB.

26. The method of claim 25, wherein said custodian report comprises a position report for one or more QIBs.

27. The method of claim 1, further comprising accessing the website through a participating broker/dealer.

28. The method of claim 1, further comprising accessing the website through a broker/dealer selected from a plurality of participating broker/dealers.

29. A computer-implemented trade reservation system that facilitates trade and settlement of one or more unregistered securities issued under an exception outlined in Rule 144A of the Securities Act, the system comprising:
a website accessible through a network;
a memory operably connected to at least one processor in data communication with the network, said memory storing a data structure that includes information relating to said one or more unregistered securities and to entities involved with the trading and settlement thereof,
one or more broker/dealer interfaces in data communication with the network, said one or more broker/dealer interfaces being configured to, on behalf of one or more interested investors, receive and process trade inquiries made by one or more broker/dealers pertaining to selected ones of the one or more unregistered securities;
an interface with a compliance manager in data communication with the network, said compliance manager interface being configured to receive a QIB status determination under Rule 144A made by the compliance manager with respect to each of the one or more interested investors;
said at least one processor being configured to allocate an investment slot to one or more eligible QIBs as determined by the compliance manager if a number of allocated investment slots is less than a regulated value, and otherwise declining to allocate an investment slot to ineligible ones of the one or more interested investors,
said at least one processor being further configured to make a security trade reservation associated with the allocated investment slot before a trade is initiated.

30. The system of claim 29, wherein said at least one processor comprises multiple processors in data communication with the network.

31. The system of claim 29, wherein the website is implemented on a server separate from said at least one processor.

32. The system of claim 29, wherein the one or more broker/dealer interfaces are implemented via a web interface to the network.

33. The system of claim 29, wherein said data structure stored in said memory includes information relating to said entities that comprises one or more of issuers of the unregistered securities, underwriters of the unregistered securities, one or more QIBs, and one or more custodians of the unregistered securities.

34. The system of claim 29, wherein said data structure stored in said memory includes information relating to said entities that comprises one or more broker/dealers of the unregistered securities, one or more QIBs, and one or more custodians of the unregistered securities.

35. The system of claim 29, wherein said data structure stored in said memory comprises a shareholder registry.

36. The system of claim 29, wherein said data structure stored in said memory includes, for each unregistered security, information relating to a market maker, a custodian, an issuer, any pending trades, any completed trades, and a share balance for each purchasing QIB.

37. The system of claim 29, wherein said data structure stored in said memory includes, for each purchasing QIB, information relating to unregistered securities in which said each purchasing QIB has a position, a market maker, a custodian, an issuer, any pending trades, any completed trades, and a share balance.

38. The system of claim 29, wherein said data structure stored in said memory includes, for each purchasing QIB and for a particular issue of an unregistered security, information relating to a purchase date, a number of shares purchased thereon, a custodian thereof, and a desired number of shares to be sold.

39. The system of claim 29, wherein said data structure stored in said memory includes, for each unregistered security, information relating to a selling QIB and a buying QIB.

40. The system of claim 29, wherein said data structure stored in said memory includes, for each unregistered security, information relating to any pending trades for a particular QIB.

41. The system of claim 29, wherein said data structure stored in said memory includes, for each unregistered security, information relating to a last trade date, a last trade price, a number of QIB investment slots already filled, and a number of QIB investment slots available for investment.

42. The system of claim 29, wherein said data structure stored in said memory includes, for each unregistered security, information relating to a last trade date, a last trade price, a number of foreign QIB investment slots already filled, and a number of foreign QIBs investment slots available for investment.

43. The system of claim 29, wherein said data structure stored in said memory includes transaction details for sales of each unregistered security including information relating to a custodian, a trade date, a share amount, and a share price.

44. The system of claim 29, wherein said data structure stored in said memory includes reporting information relating to any sales of each unregistered security, said reporting information including, for each sale, an issue name, identifying information for a selling QIB, identifying information for a purchasing QIB, a number of shares traded, and a price per share.

45. The system of claim 29, wherein the at least one processor is configured to enforce an investment limit established by an issuer for each allocated investment slot.

46. The system of claim 29, wherein the processor is configured to account for a sale of specific shares of a particular security to each purchasing QIB via a book-entry record.

47. The system of claim 29, further comprising a notification manager configured to provide notifications of each sale of unregistered securities to selected ones of the entities involved with the trading and settlement.

48. The system of claim 29, wherein the at least one processor is configured to provide required notifications of each associated sale to a transfer agent.

49. The system of claim 29, wherein the at least one processor is configured to provide e-mail notifications of each associated sale via one or more e-mails sent to selected ones of the entities involved with the trading and settlement.

50. The system of claim 29, further comprising an interface via the network to one or more custody managers configured to manage custody of one or more purchased shares on behalf of one or more purchasing QIBs.

51. The system of claim 50, wherein the custody manager interface is configured to monitor custody of the one or more purchased shares by a third party.

52. The system of claim 29, wherein the regulated value is 500 U.S. investors under said Rule 144A of the Securities Act.

53. The system of claim 29, wherein the regulated value is 300 investors when one or more of the investors is a non-U.S. investor under said Rule 144A of the Securities Act.

54. The system of claim 29, wherein the at least one processor is configured to create a report incorporating reporting information relating to a trade of an unregistered security.

55. The system of claim 54, wherein the at least one processor is further configured to interface with a spreadsheet program and to export selected portions of the reporting information into a spreadsheet.

56. The system of claim 54, wherein the at least one processor is further configured to generate a custodian report for a selected purchasing QIB.

57. The system of claim 56, wherein said custodian report comprises a position report for one or more purchasing QIBs.

58. The system of claim 29, wherein the website is accessible to interested investors only through a participating broker/dealer interface.

59. The system of claim 29, wherein the website is accessible to interested investors only through a plurality of participating broker/dealers interfaces.

60. The method of claim 1, further comprising, after said allocating an investment slot and said making an associated security transfer reservation, receiving an indication from a broker/dealer that a trade has been executed.

61. The system of claim 29, wherein said at least one processor is further configured to receive an indication from said one or more broker/dealers via the network that a trade has been executed.

62. A computer program product for use with a computer in connection with trading and settlement of unregistered securities issued under an exception outlined in Rule 144A of the Securities Act, said computer program product containing computer-readable instructions thereon which, when executed on the computer, cause the computer to:
interface with a network;
establish a data structure stored in a memory that includes information relating to one or more unregistered securities and entities involved with the trading and settlement thereof,
process trade requests from one or more interested investors pertaining to one or more of the unregistered securities;
receive a Rule 144A Qualified Institutional Buyer (QIB) eligibility status from a compliance manager for each of the one or more interested investors;
determine one or more QIBs from the QIB eligibility status for each of the one or more interested investors;
allocate an investment slot to said one or more QIBs if a number of allocated investment slots is less than a regulated value; and
for each allocated investment slot, making an associated security transfer reservation before a trade is initiated.
